(19) United States
(12) Patent Application Publication
(10) Pub. No.: US 2015/0312618 A1
(43) Pub. Date: Oct. 29, 2015

(54) Systems and Methods for Generating a Full-Motion Video Mosaic Interface for Content Discovery with User-Configurable Filters

(71) Applicant: ActiveVideo Networks, Inc., San Jose, CA (US)

(72) Inventors: David McElhatten, Marina del Rey, CA (US); Devin Agnew, Los Angeles, CA (US); Jack Johnson, Canyon Country, CA (US); Michael Mercolino, Studio City, CA (US); Alan Mih, Culver City, CA (US)

(21) Appl. No.: 14/698,633

(22) Filed: Apr. 28, 2015

Related U.S. Application Data
(60) Provisional application No. 61/985,412, filed on Apr. 28, 2014.

(51) Int. Cl. H04N 21/431; H04N 21/258; H04N 21/4545; H04N 21/482; H04N 21/4788

(52) U.S. Cl. CPC H04N 21/431; H04N 21/4828; H04N 21/4788; H04N 21/4545; H04N 21/25891

(57) ABSTRACT

A method for generating an interactive graphical user interface is performed at a server system remote from a client device. The server system receives, from the client device, user input selecting a first filter, and filters available video programming using one or more search conditions corresponding to the first filter, to identify a first plurality of videos that satisfy the one or more search conditions. The one or more search conditions include a criterion relating to a popularity metric for a social network. The server system generates a user interface that includes a first mosaic of selectable video tiles corresponding to the first plurality of videos. Respective videos of the first plurality of videos are played in respective video tiles of the first mosaic. The server system encodes the user interface as a video stream and transmits the video stream containing the user interface toward the client device for display.

### RELATED APPLICATIONS

This application claims priority to U.S. Provisional Patent Application Nos. 61/985,412, titled “System and Method for User-Configurable, Full-Motion Video Mosaic System,” filed Apr. 28, 2014, which is incorporated by reference herein in its entirety.

### TECHNICAL FIELD

The present disclosure pertains generally to cable television network technology, and particularly to graphical user interface systems and methods optimized for interactive, user-configurable, on-screen electronic program guides.

### BACKGROUND

As video and television content choices have proliferated, it has been an increasing challenge to simplify the process of content discovery and selection. Cable system operators face increasing competition with Internet and other digital delivery systems which offer the user search and delivery flexibility that has been impossible to replicate on cable television networks employing QAM video systems and legacy set-top boxes. In the case of legacy cable systems, each video stream requires a separate tuner to render and display it, and having more than two or three tuners in any device is commercially impractical. Though certain high-end cable TV set-top boxes may have four or more tuners, their deployment is costly and, hence, rare.

While on screen graphics representing available programming (e.g., “thumbnails”) have been used for at least the past decade, without some means of flexible sorting and self-organizing, a large array of full-motion video windows might provide more of a distraction than benefit. However, a system capable of dynamically formatting a custom-created matrix using full-motion video to represent each of the programming choices has been a challenge due to the aforementioned issues with multiple tuners in a set-top box.

To stay competitive with alternative programming sources, cable system operators need a content discovery environment that enables users to choose a desired program based on a full-motion visual representation and which also consolidates discovery and access to programs available over multiple services. Programs that are discoverable to the subscriber by such means should include currently broadcasting content such as live or real-time broadcasts, upcoming broadcasted content, and locally or remotely-stored video content such as video-on-demand and remote Internet-available video storage services such as YouTube and should also include subscriber-based storage such as content pre-recorded on a connected DVR.

Further, in addition to being able to use common search filters such as time, channel, and the genre of the programming, the content discovery process should include capabilities similar to Internet search engines. This should include key-word searching of the metadata associated with desired content, as well as metrics of specific content's current popularity with other viewers, both locally and nationally.

### SUMMARY

Systems and methods are provided that are capable of solving many problems of discovery and selection for TV programming, movies, video, and other content offered over digital TV or IP networks. A server system generates a “Personalized Content Navigation” (PCN) video mosaic where every “tile” can be simultaneously displayed in full-motion video with optional audio. The size, location and arrangement of the tiles may be changed. These video representations are rendered “in the cloud” and are delivered and displayed without reliance on the characteristics of the customer premises equipment such as the number of tuners available in the TV set or set-top box.

The interface may be reformatted, controlled, and navigated by the viewer not only with the television's remote control, but also with a laptop, tablet, smart phone, or most any other mobile device which may be used to dynamically configure the mosaic to present availability of programming content sorted by a wide range of criteria. The PCN serves as the primary user interface (UI) for the subscriber's service.

In some embodiments, the server system enables television subscribers to select and display various programs, movies, videos, or other media offerings in a mosaic where the individual tiles are dynamically sorted and grouped based on how well the programming's metadata match the subscriber's requests, on the real-time popularity of specific programming on the subscriber's system or specific social-media platforms, or by the types of programs that the subscriber has previously watched on particular days of the week or during a certain time of day.

In some embodiments, the server system monitors, via the Internet, various social media sites such as, by way of example only and without limitation, Twitter, Facebook, and Instagram, and builds a real-time database calculating for example, the rank or popularity of any television programming or specific performers carried by the subscriber's provider as well as other programming available via the internet. Sorting options can include the popularity of certain programming on social media as measured by trending patterns, or other metrics such as numbers of Tweets, Likes, Mentions, or similar references on various social media to specific content choices that are available to a viewer.

From this central database of computed “popularity” rankings derived from social media sources, the server system dynamically manipulates the order of the full-motion-video tiles based on the popularity of the programming as directed by the social media “popularity” database. The server system then enables the user to build a mosaic display of video tiles showing programming of interest to that individual as determined by, for example, the shows most tweeted about or “liked” on one or more social media platforms.

In some embodiments, the server system can detect mentions of programming on social media by a certain actor's name, character's name, episode name, or program name and then search a TV program guide database to identify the specific programming being referenced in the monitored social media. The server system can also watch for certain keywords and dynamically add a program to the video tile mosaic if it is of changing importance, such as determined by a sudden increase of mentions or Tweets about a particular keyword, actor, or program name. The server system can also configure the video mosaic to devote a line of video tiles labeled with the names of the user's friends who are currently viewing that programming, assuming the friends are also served by the server system (e.g., which is part of a cable system).

In some embodiments, a method for generating an interactive graphical user interface is performed at a server system remote from a client device. The method includes receiving, from the client device, user input selecting a first filter and filtering available video programming using one or more search conditions corresponding to the first filter, to identify a first plurality of videos that satisfy the one or more search conditions. The one or more search conditions include a criterion relating to a popularity metric for a social network. The method also includes generating a user interface that includes a first mosaic of selectable video tiles corresponding to the first plurality of videos. Respective videos of the first plurality of videos are played in respective video tiles of the first mosaic. The method further includes encoding the user interface as a video stream and transmitting the video stream containing the user interface toward the client device for display.

In some embodiments, a server system includes one or more processors and memory storing one or more programs configured to be executed by the one or more processors. The one or more programs include instructions for performing the above-described method. In some embodiments, a non-transitory computer-readable storage medium stores one or more programs configured for execution by one or more processors of a server system. The one or more programs include instructions for performing the above-described method.

Systems and methods are thus described for simplifying and personalizing an individual television viewer's discovery of available programming content through the interactive creation of a Personalized Advanced Content Discovery service using a video mosaic of full-motion elements or “tiles.” The system enables any user to explore available broadcast and on-demand programming; not only by the typically used categories of channel number, time slot, program name or genre, but also by other sorting options such as the user's previous viewing patterns based on the day of the week or time of day or specific metadata searches. Other options could include programming available on the user's digital video recorder, or available from other sources such as programming delivered over the public internet. Yet further means are provide to filter programming such as by popularity of certain programming on social media as measured by numbers of or trending patterns of Mentions, Tweets, Likes or similar references on various sites to the content choices that are available to a particular viewer.

In addition to the basic description and other metadata of available programming, users see each potential choice as a “tile” that is part of a high definition mosaic of multiple picture-in-picture displays, all displayed simultaneously in full motion and often showing the actual programming then in progress. The user experience is self-revealing, in that the user sees the actual video of the content represented playing on the tile. Upon selection of a tile by a user, audio of the video tile content may be presented, and more detailed information about the content the tile represents may be displayed. The mosaic of simultaneous full-motion video tiles are rendered “in the cloud” and are delivered to the user's TV or to other chosen viewing devices over a system operator's quadrature amplitude modulation (“QAM”) video network, by means of a private digital network or the public Internet. Likewise, the mosaic display can be viewed on an Internet-connected device capable of decoding video.

### BRIEF DESCRIPTION OF THE DRAWINGS

For a better understanding of the various described embodiments, reference should be made to the Detailed Description below, in conjunction with the following drawings. Like reference numerals refer to corresponding parts throughout the figures and description.

FIG. 1 is a high-level block diagram of a client-server networking architecture in accordance with some embodiments. Disclosed methods are implemented on a computer system that is a functional video-processing unit 101 which is in turn a component of a Server System 100. Information on available programming is received from sever 102 and other sources. The full-motion user interface is rendered in video-processing unit 101 and transmitted to the client device 106 over a QAM network 103, to a client device 107 over a private IP network 104, or to a client device 108 over the public Internet 105 for viewing. (Client devices may also be referred to simply as clients.)

FIG. 2 shows a high-level block diagram of a typical client device where content (e.g., the full-motion user interface) is viewed (i.e., consumed). The client device is typically a cable or satellite (i.e., multi-channel video program distributors) set-top box. While such client devices have one or more TV tuner(s) 203 built in, even with two or three tuners, such a client typically does not have the capability to extract and render on screen more simultaneous video streams than it has tuners. Hence, a program guide generated by the client device could display, for example, three video images simultaneously. Some embodiments, on the other hand, can be described as a virtual set-top box centrally located in the cable TV headend or other regional processing facility where the virtual set-top box can draw on computer and communications resources not available to a set-top box in a consumer's home. The virtual set-top box provides a “virtual tuner” for every video program carried by the cable or satellite system or available over the Internet. Hence, instead of only three video windows of programming displayed simultaneously using the set-top box in the home, the virtual set-top box can generate and send to the client device a video image containing, for example, tens of video windows for different respective video sources (e.g., 30 video windows of 30 different video sources). On newer ultra-high definition televisions (e.g., 4K HDTV), the virtual set-top box could potentially render hundreds of video windows (e.g., 300 video windows) to be displayed on a single screen via the client device.

FIG. 3 shows a representative screen image 301 of an HDTV video mosaic display in accordance with some embodiments. In this example the mosaic displays the current programming available for the first thirty channels sorted by ascending channel number. All the individual tiles in the display are displaying full motion video. In this example the first channel has been selected 302 and audio is available to accompany the full motion video.

FIG. 4 shows a representative screen image 401 of an ultra-high-definition video mosaic display displayed on a 4K HDTV television set in accordance with some embodiments. The screen image 401 includes 88 full-motion video tiles and channel 20 has been selected 402 and the audio 403 for that feed is active.

FIG. 5 shows a diagram of the arrangement of a video mosaic interface 501 in Source Set-Up Mode in accordance with some embodiments. A control widget 504 has been remotely manipulated by the user to move the selector button 503 to hover over a particular video tile 502 and thereby select that video feed.

FIG. 6 shows a diagram of the arrangement of a video mosaic interface 601 showing the result of the selection made in FIG. 5 with a presentation of an overlay window 603 displaying a column of potential choices 604, in accordance with some embodiments.

FIG. 7 shows a diagram of the arrangement of a video mosaic interface 701 showing the result of the selection made in FIG. 6 with a presentation of an overlay window 703 displaying a column of additionally filtered potential choices 704 with a choice 705 being made to filter by Cable Channels offering sports programming, in accordance with some embodiments.

FIG. 8 shows a diagram of the arrangement of a video mosaic interface 801 showing the result of the selection made in FIG. 7 with a presentation of an overlay window 803 displaying a column of additionally-filtered potential choices 804 with a choice 805 being made to filter by a particular Cable Channel offering sports programming, in accordance with some embodiments.

FIG. 9 shows a diagram of the arrangement of a video mosaic interface 901 showing the result of the selection made in FIG. 8 with a presentation of an array of programming meeting the choices made previously in accordance with some embodiments. In this example, an array of 15 potential programs shows sports-related programming available on ESPN1. Such programming is displayed in a mosaic of full motion “video tiles.” In this example, the user has selected one such tile 902 by moving the selection widget 903 to cover it. The audio may be heard by activating affordance 905 and the video may be expanded by activating affordance 906.

FIG. 10 shows a diagram of a video mosaic interface 1001 after activating affordance 906 in FIG. 9 in accordance with some embodiments. The full motion video of the specific programming just selected is displayed in an enlarged window optionally with its associated audio played in response to activating affordance 1005. Activating affordance 1006 causes a transition to the interface diagramed in FIG. 11.

FIG. 11 shows a diagram of a video mosaic interface that can be invoked by taking the action shown in FIG. 10 in accordance with some embodiments. In this case, the programming selected through the process shown in FIGS. 8, 9, and 10 is now further expanded—with or without audio at the viewer's option—to nearly full screen 1103 and the video mosaic of the alternative programming choices available but not yet selected is moved to a different part of the screen (e.g. the right side) with an unexpanded version 1102 of the expanded video 1103 also shown in the mosaic, which may be sorted or rearranged 1107 by the user.

FIG. 12 shows a diagram of a video mosaic interface resulting from the viewer activating affordance 1106 in FIG. 11 in accordance with some embodiments. In this case the chosen video is playing in a larger window 1204 (i.e., larger than window 1103) but one that is still slightly reduced from full frame 1201. The video being played in the window 1204 is also shown in a greatly reduced-size video mosaic tile 1202 in the video mosaic tiles that remain (e.g., on the right side of the screen). The video mosaic tiles continue to display additional related or similar sports programming. At any time, selection widget 1203 may be manipulated to choose any of such alternative programming.

FIG. 13 is a screen shot 1301 taken from a TV viewing device acting as a client in accordance with some embodiments. In this example, the client TV viewing device is being provided with a video mosaic of eight streams creating a mosaic of eight full-motion-video tiles. These streams have been selected from the TV programs then available on a particular cable TV system, which are shown by an external real-time rating system being used as the “most popular.” In this example, the most popular of the streams (e.g., ranked as the show that is most popular in the market) is a re-run of President Obama's appearance as a guest on The Tonight Show.

FIG. 14 is a screen shot 1401 continuing from FIG. 13 in accordance with some embodiments. The user is selecting 1405 the menu option 1404 to activate a personalized filter. A speaker icon 1403 for the first video tile 1402 shows that the viewer has elected to hear the audio associated with the selected video stream.

FIG. 15 is a screen shot 1501 continuing from FIG. 14 in accordance with some embodiments. The user is selecting 1502 the menu option to activate a personalized filter, which is a preset filter 1503 that the user has made at a prior time and which in this particular example contains a list of favorite filters, specifically programming that “Mom” and “Dad” consider to be favorites. This example list of filters is arbitrary in selection and size.

FIG. 16 is a screen shot 1601 continuing from FIG. 15 in accordance with some embodiments. A previously made custom filter 1603 (“Mom's Favorites—Late Night”) is selected and applied 1602.

FIG. 17 is a screen shot 1701 showing the results of applying the custom filter 1702 as titled on screen, in accordance with some embodiments. In this example the audio for tile #1 is playing as shown by the icon 1703.

FIG. 18 is a screen shot 1801 of the next screen showing available programming meeting the criteria for the custom filter “Mom's Favorite—Late Night” 1803, in accordance with some embodiments. In this example, tile 1802 has been selected and its audio activated as indicated by icon 1804.

FIG. 19 is a screen shot 1901 that shows the programming available meeting the custom filter “Mom's Favorites—Primetime Comedy” 1903, which in this example includes Big Bang Theory 1902 that has been selected and its audio activated 1904, in accordance with some embodiments.

FIGS. 20A-20C are screen shot 2001A, 2001B, and 2001C showing the use of another custom filter menu 2002 (“Show Social Network Filters”) that, in accordance with some embodiments, enables the selection 2003 of an additional array of filters 2004 that enable selection of programming based on reactions on various internet social media networks to the programming. The array of filters 2004 includes a filter “Talk Shows Trending the Most (All Social Media Sources),” the selection of which in FIG. 20B results in display of the mosaic of FIG. 20C.

FIG. 21 is a screen shot 2101 of the television viewer selecting 2102 the additional filter of programming that has been determined to be the ones which have been commented on (e.g., Tweeted about) the most by users of a social media platform (e.g., Twitter), in accordance with some embodiments.

FIG. 22 is a screen shot 2201 showing the result of the television viewer using a filter 2202 to search for 2202 available programming that, in this example, has been most frequently commented on (e.g., referenced by users of the Twitter social media application) in a social media platform, in accordance with some embodiments. The screen shot 2201 presents a selection of available programming identified using the filter.

FIG. 23 is a screen shot 2301 of the result of the television viewer combining a plurality of filters in one search, in accordance with some embodiments. In this example, the viewer uses a filter 2302 to combine the single filter “Shows You Like” as applied in FIG. 17 (with the viewer “Mom” as the example system user) with the single filter “All Shows Most Tweeted About” as applied in FIG. 22. This causes the server system to select, from the shows the user likes, the shows most mentioned by users of the Twitter social media application.

FIG. 24 is a screen shot 2401 of the result of the television viewer adding additional filters to an existing search in accordance with some embodiments. In this example the filter “Comedy Shows” and the filter of FIG. 23 (“Shows You Like Most Tweeted About”) have been added to the search that was previously initiated in FIG. 17 to find programming “liked” by the viewer, to return the conflated search results noted by the phrase 2402 (“Comedy Shows You Like Most Tweeted About”).

FIG. 25 is a flow chart diagramming the steps involved in setting up a video mosaic display of available programming by genre and with additional filters as desired, in accordance with some embodiments. The process starts at 2501, with the user selecting each channel to be included as a full-motion tile in the mosaic display 2502. Once all channels of interest are included 2503 the user has an option 2504 to re-arrange 2505 by time of day or day of week. A mockup of the newly configured display 2506 is seen and can then be modified by the user to enable other filters and arrangements that meet the user's preferences such as by arranging 2507 the mosaic to take into account the popularity of programming on various social networks, arranging 2508 the mosaic as preferred by various family members, or arranging 2509 how various family member's choices are displayed, which concludes 2510 the initial set up process.

FIG. 26 is a flow chart diagramming the steps involved in setting up a video mosaic display of available programming arranged according to individual family member's preferences, in accordance with some embodiments. The set-up is initiated in 2601 and the user selects “custom” video mosaic configuration 2602 and indicates 2603 if the custom configuration includes a plurality of family members, requiring more than one video mosaic 2606. If a plurality of family members is using the features of the video mosaic display of available programming, the server system defaults to arranging the video tiles for each family member based on the frequency of their usage, 2605.

FIG. 27 is a flow chart diagramming the steps involved in setting up a video mosaic display of available programming arranged according to popularity or mentions on various social networks on the internet, in accordance with some embodiments. The set-up is initiated in 2701 and the user selects “custom” video mosaic configuration 2702 and indicates 2703 if the custom configuration is to include a filter that weights various social network metrics in determining what potential programming choices are displayed. The initial step in that process includes determining which social network(s) to reference 2706, and what key words to use, 2707 Key words may include, by way of example only, the names of various TV shows, show episodes, names of actors, performers, athletes, or other individuals associated with certain programming. The user also has the option of adding 2708 short term favorites 2709 such as for example a pilot show, new season opener, or other non-repeating events. The system then updates 2704 and rearranges the video tiles in the mosaic display ending the session 2705.

FIG. 28 shows an on-screen chart 2801 through which a user can set up different mosaics for each day of the week and for each time period (day part) of the day and by the most likely users (e.g., “Dad” or “Mom”), in accordance with some embodiments.

FIG. 29 shows an on-screen chart 2901 through which a user can set up different video mosaics in accordance with some embodiments. In this example the user can configure the chart to inform the server system which type of sports has priority at certain times of the year. In some embodiments, the times of the year are the ordinary seasons intermixed with the addition of the playoff seasons of the major sports categories.

FIG. 30 is a flow chart showing the steps taken by a user to direct the server system to develop and provide for display a chart of available sports programming such as shown in FIG. 29, in accordance with some embodiments.

FIG. 31 is diagram that is representative of the sequential steps taken by a user to direct the server system to develop and display an on-screen mosaic of the channel and movie show time(s), when certain selected pay per view movies are available to be viewed.

FIG. 32 is a representation of a screen 3201 displaying a video mosaic created through the method of FIG. 31 in accordance with some embodiments. In this example, four movies have been selected with the preview 3202 of each movie being displayed in the left-most column of the mosaic of full-motion-video tiles. Each of the available movies is offered with starting times every 15 minutes. In this example, the user has used the selector tool 3204 to chose Movie 2 3206 in the 7:45 time slot 3203. However, in this screen depiction, clock time 3207 is now almost five minutes past the actual movie start time. The user has the option of missing the beginning of the movie, waiting about ten minutes for the next start time, or instructing the server system to simulate a digital video recorder (DVR) type of experience for the user by dragging the movie progress bar 3208 back to the beginning of the 7:45 time slot 3203, in effect doing a virtual “rewind.”

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

The present embodiments consolidate and integrate the content discovery process for all programming available to the cable-television or other video-content-consuming subscriber. This content may be available from the subscriber's cable or other broadband provider, and may also include content from the public Internet or content locally stored such as on a DVR, into a single, viewer-configured on-screen mosaic of full-motion-video tiles easily configured to display available programming in any of a number of user-specified arrangements.

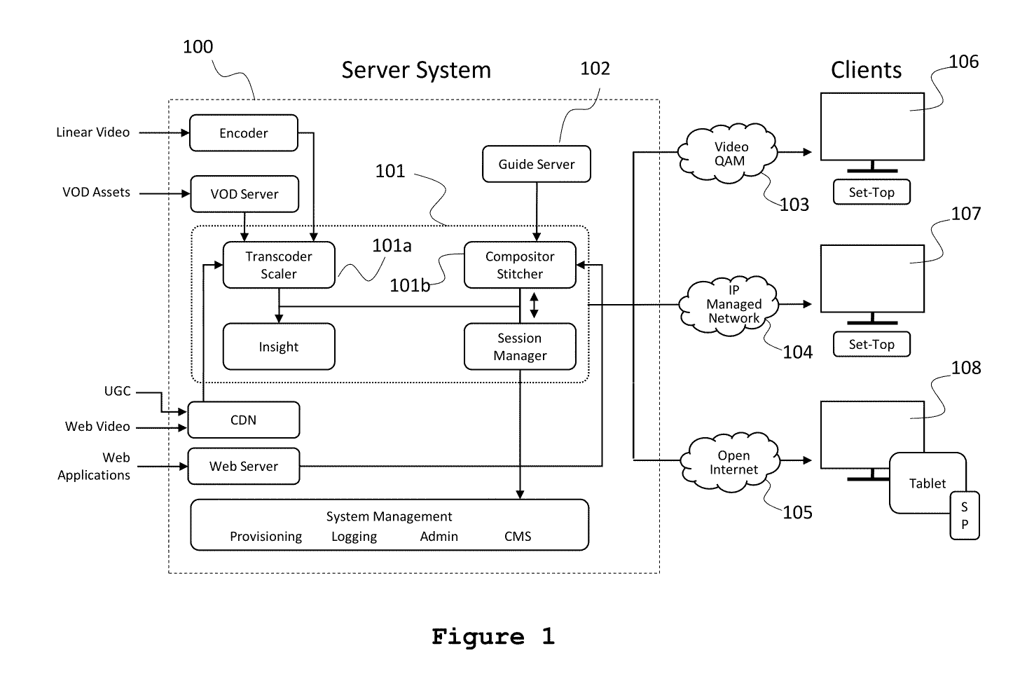

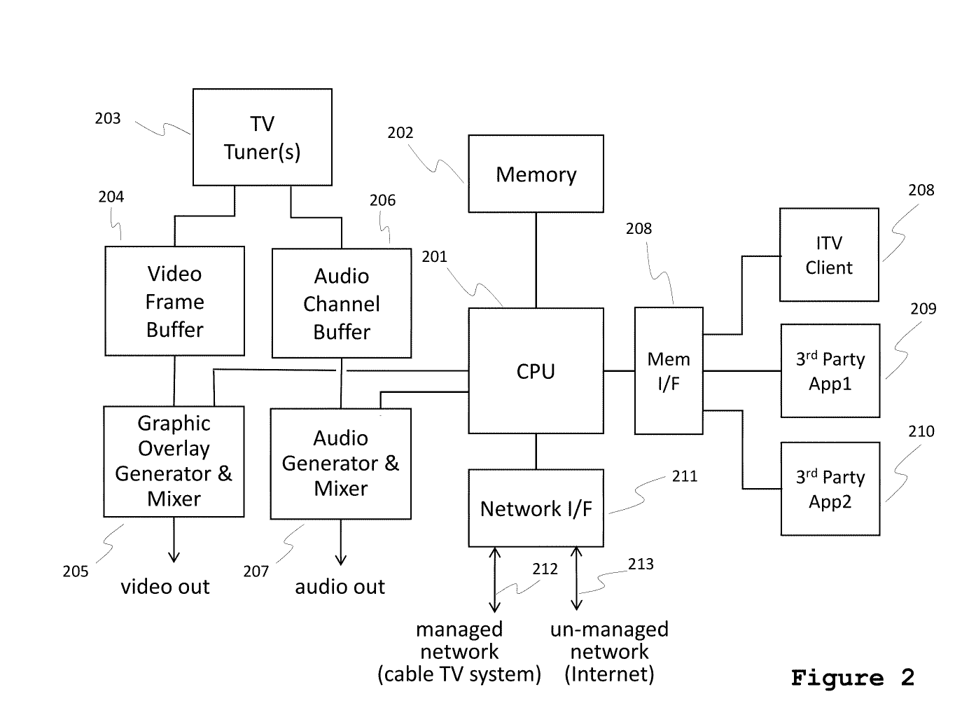

A server system (e.g., application server platform 100, FIG. 1) can dynamically assign content from any channel or other source to display on any of the full-motion-video tiles making up the mosaic display of the on-screen user interface. The server system can use continuously-updated metadata associated with the available programming. Such metadata may include, by way of example only and without limitation, broadcast time, channel, the name of the program, movie, or video. Server-side assembly of a user interface in accordance with some embodiments is described in U.S. patent application Ser. No. 14/298,796, “Overlay Rendering of User Interface Onto Source Video,” published as U.S. Patent Application Publication No 2014/0366057, which is incorporated by reference herein in its entirety.

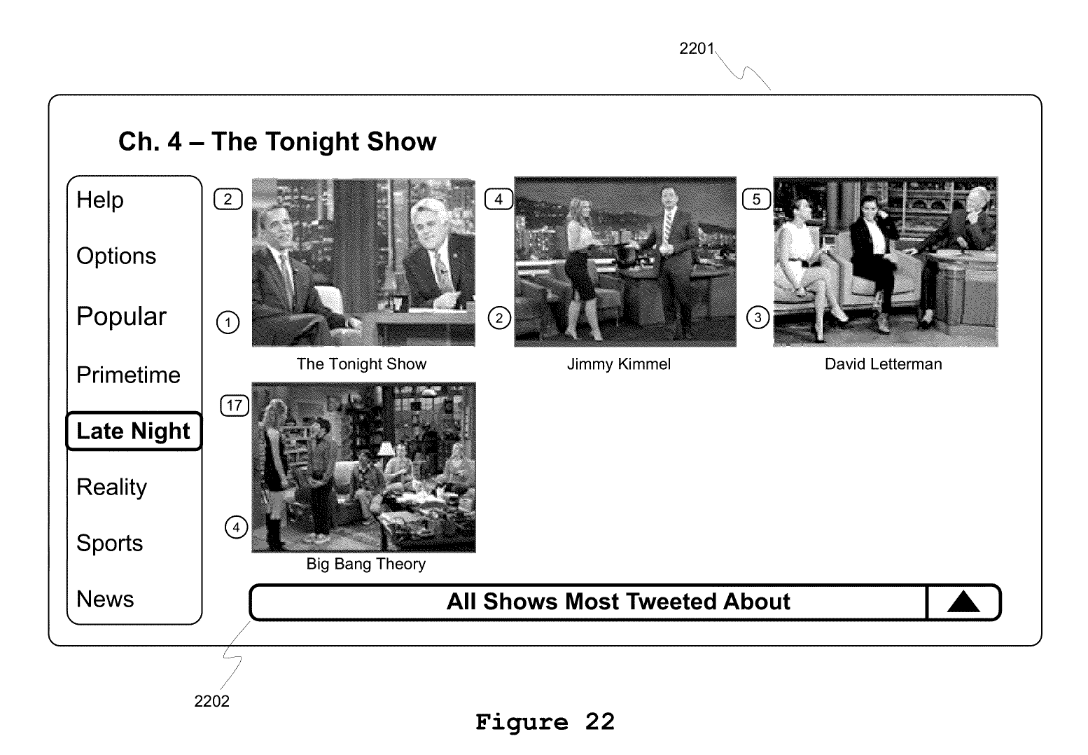

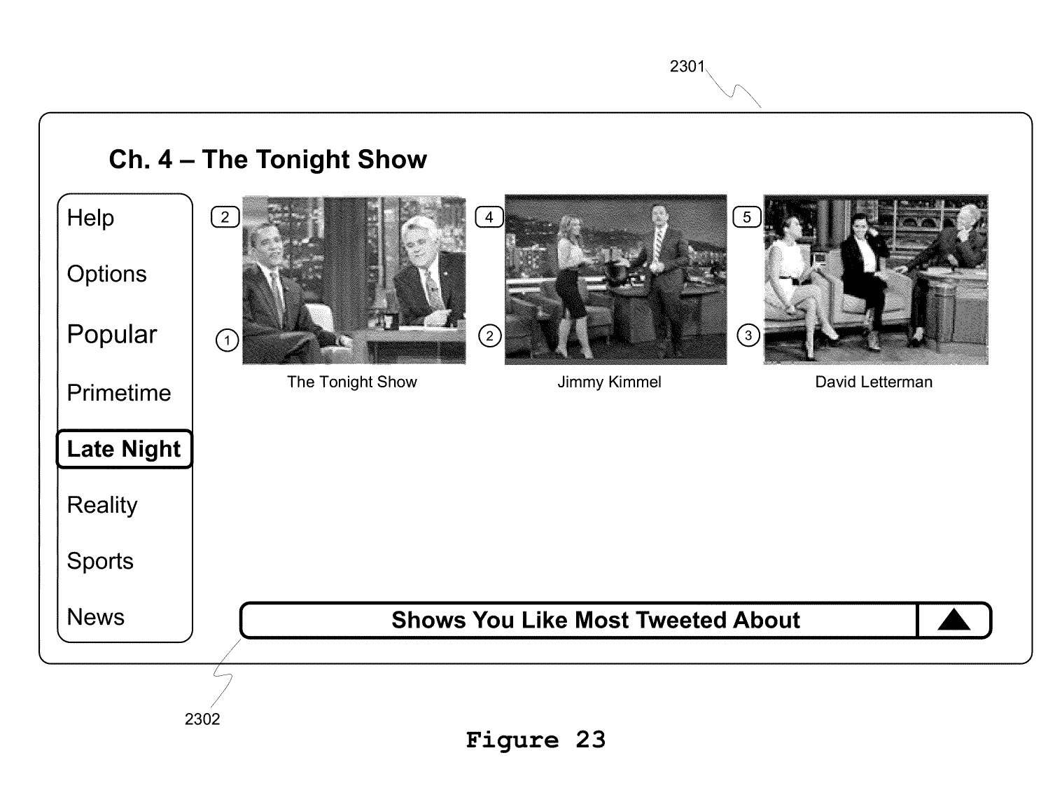

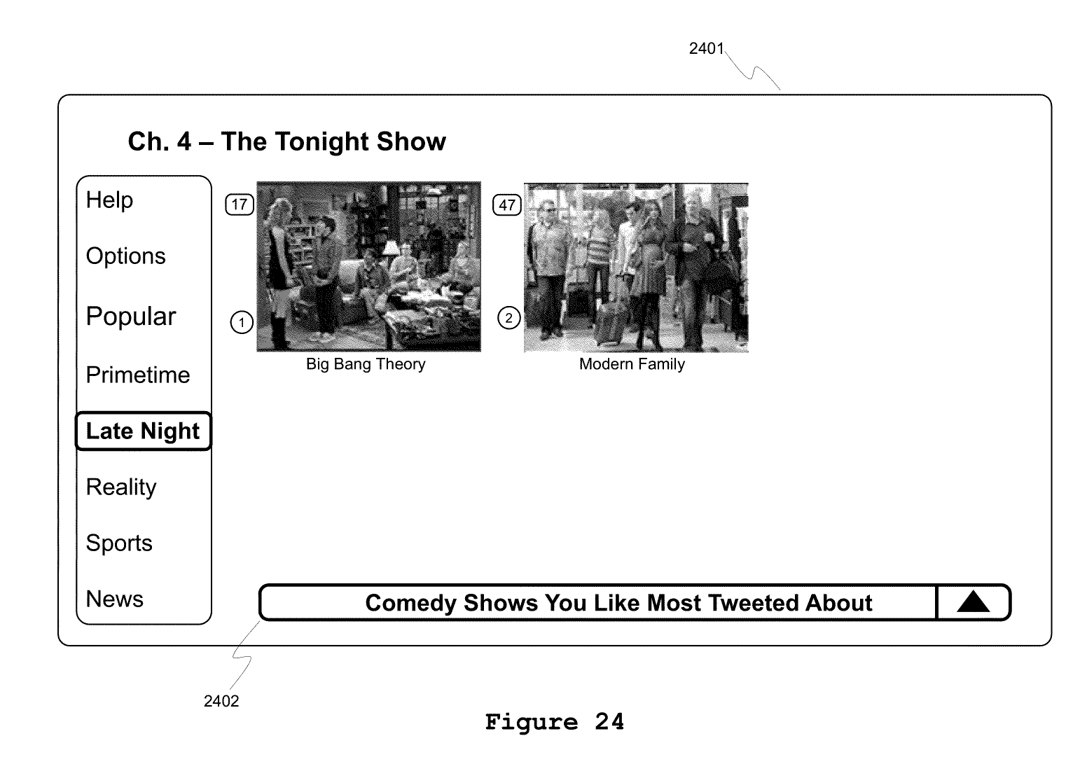

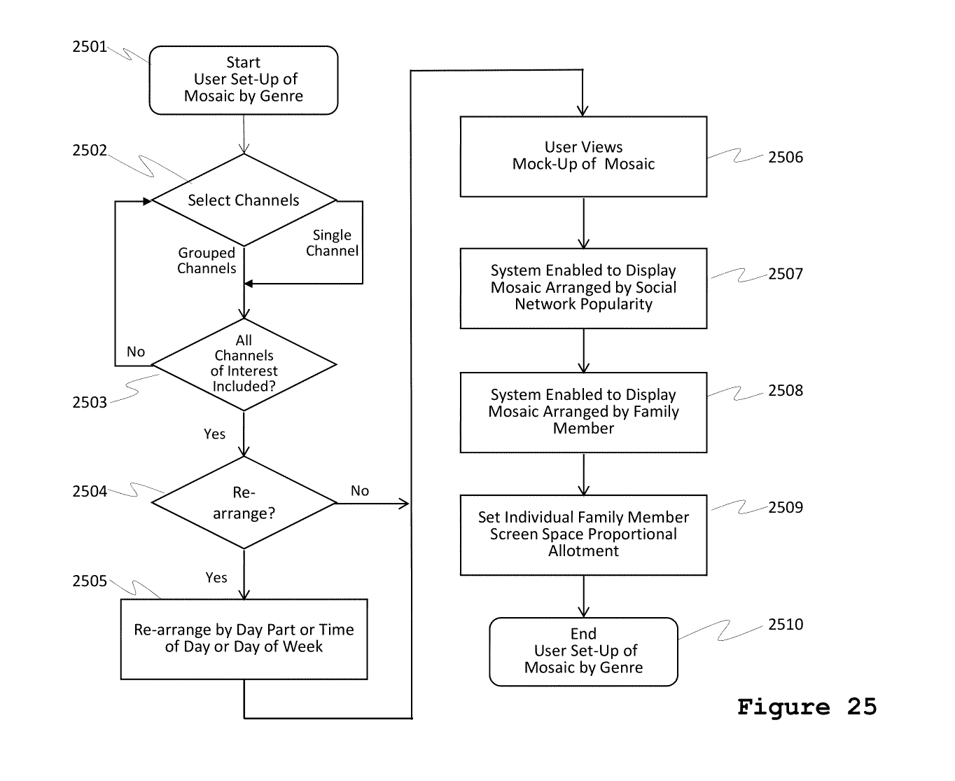

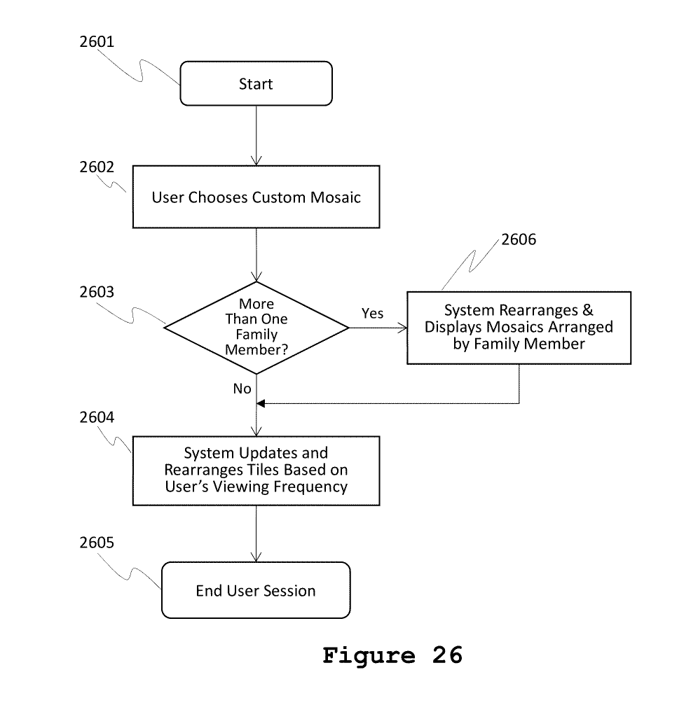

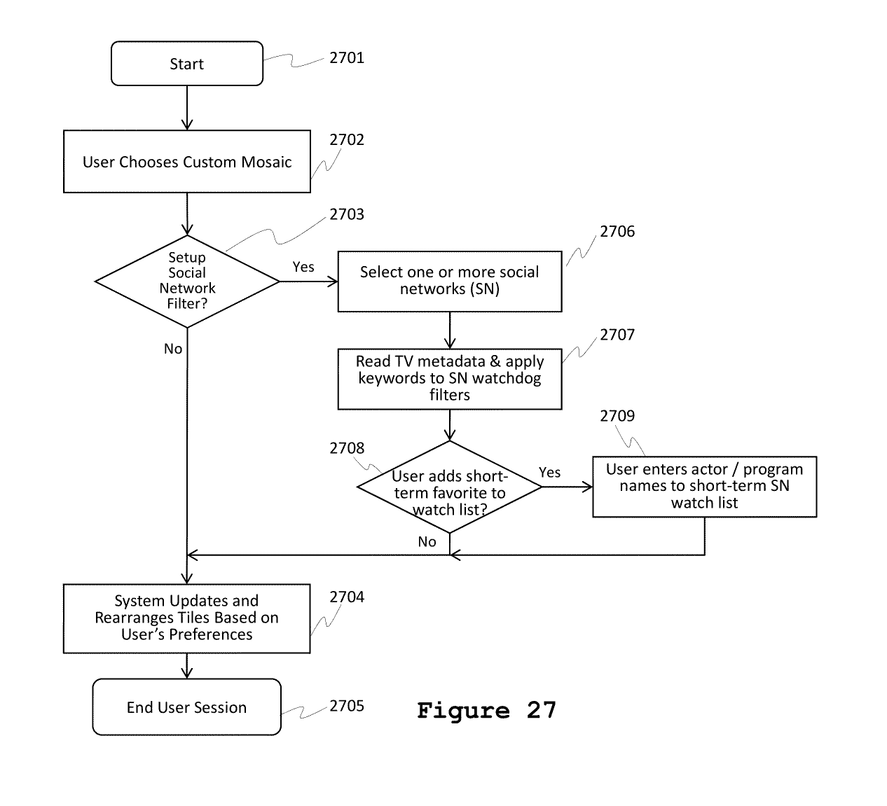

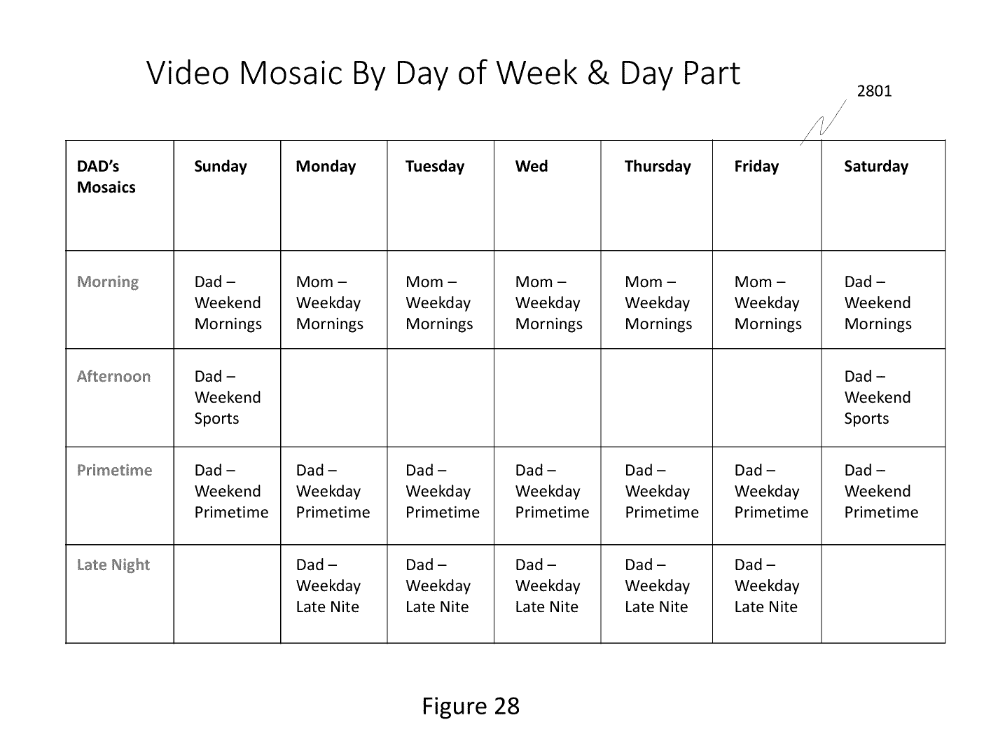

It can also search and arrange the elements or tiles of full-motion video by episode, rating, genera, genre, actors or presenters, and program reviews from various sources. Further, it can also display tiles representing available programming sorted by real-time popularity of that program by region (e.g., neighborhood, city, or other region), as measured by the number of other system subscribers currently watching the subject broadcast, or by analysis of various social media measurements such as total or trending mentions, likes, or tweets or other metrics. See FIG. 22 as one example.

The server system can also be used as the basis for a personalized social network in that a list of a TV viewer's friends can be entered into the server system by sending an e-mail, text or other communication to the server system. The server system builds a video mosaic of the channels being most watched by those friends as determined by analyzing a viewer's friends' current TV viewing as detected by Twitter feeds, Facebook or other social media “Likes” or comments.

Alternatively if the friends are on the same multichannel system, the server system can read the channel each identified friend is viewing from the multichannel video program distributor's set-top box as returned to the system head-end. The on screen video mosaic interface may or may not identify the friends who are watching a particular channel depending on the preferences of viewers or the video distributors' policies.

Any filter or triggering criteria associated with a user's personal preferences can also be set by the user to issue alerts when certain conditions are satisfied. For example, a certain user may wish to be notified when a particular actor or show is receiving a large number of mentions on social or traditional media. As a specific example, a user may wish to be notified if a certain actor's appearance on a particular show is trending on Twitter, Facebook, etc.

An item may be “trending” if it satisfies a popularity condition, such as a certain number or rate of “likes,” “retweets,” “mentions,” “up-votes,” or the like. If such a condition is satisfied, a text message with a screen image of the show may be sent to the user's smartphone to alert the user to the program. Similarly, an image could have been sent to the user's Instagram account or other similar social networking service. Any of the filters or triggering criteria created by the user for the display video in tiles on the television can be used to alert the user via message systems such as SMS or appropriate smartphone apps, and vice versa.

Similarly, any filter or triggering criteria associated with a particular user's personal preferences can also be set by the user to stream a live video feed to the user's smartphone, tablet, or laptop computer for viewing of a program. For example, where a particular actor's appearance on a certain show is trending on a social network, live video of the show may be streamed to a user's device. Similarly, any filter or triggering criteria associated with a particular user's personal preferences (such as those described above) can also be used to cause a DVR or other recording device to record the program.

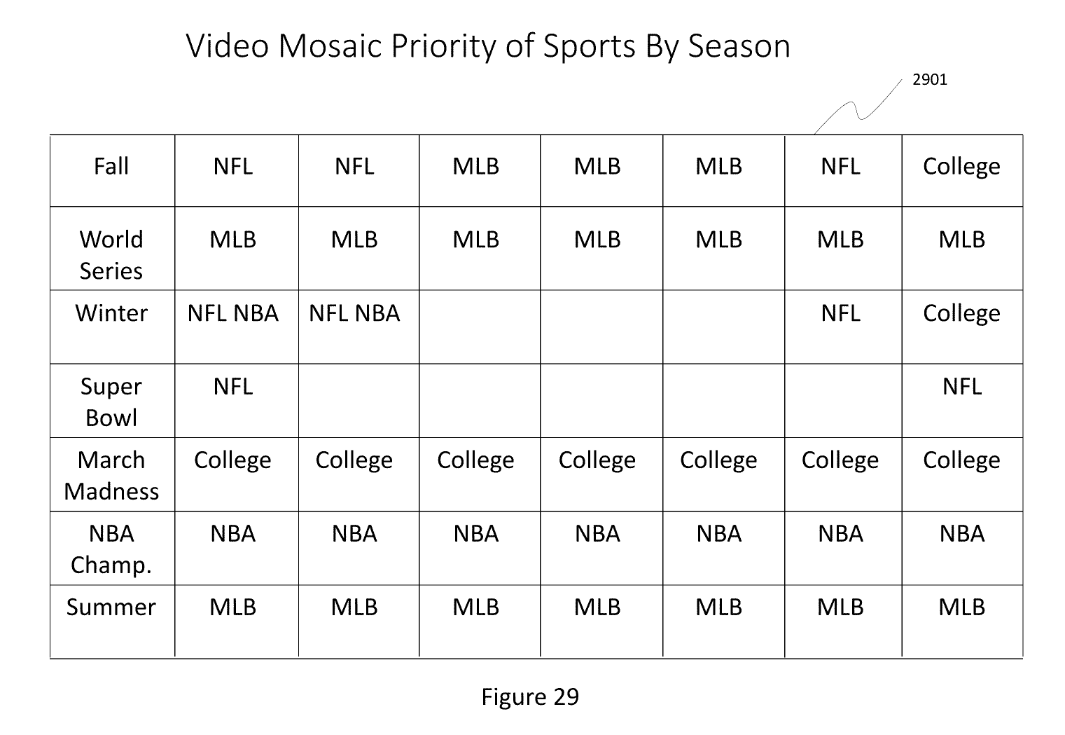

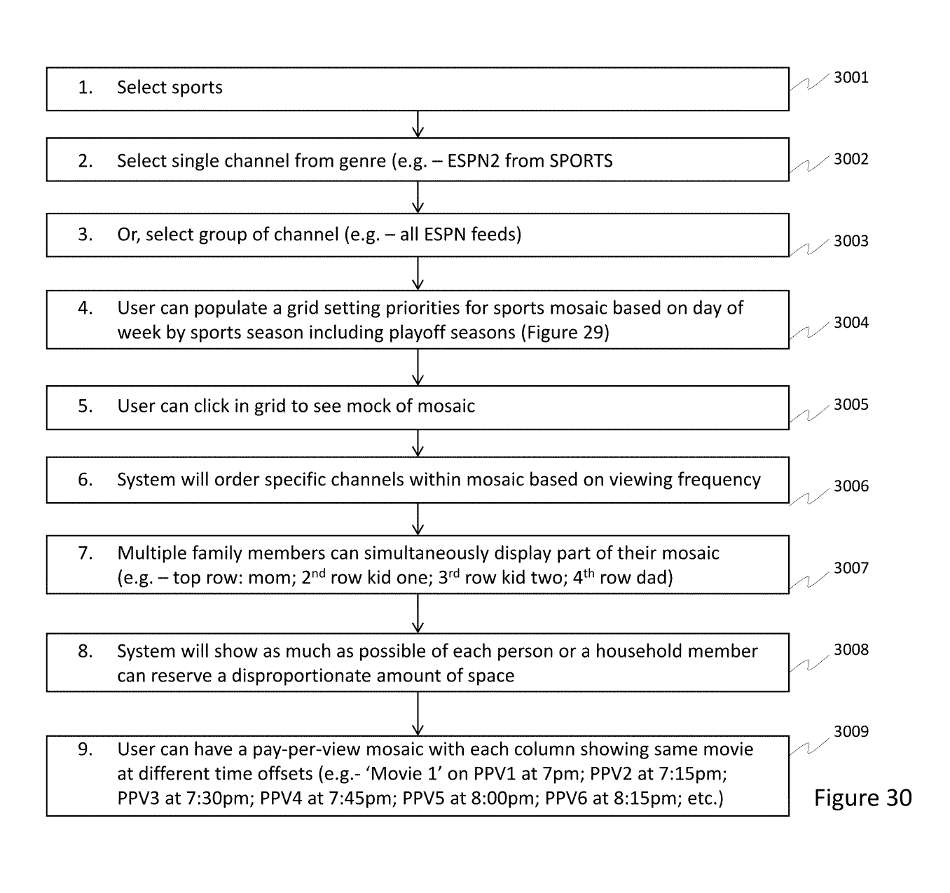

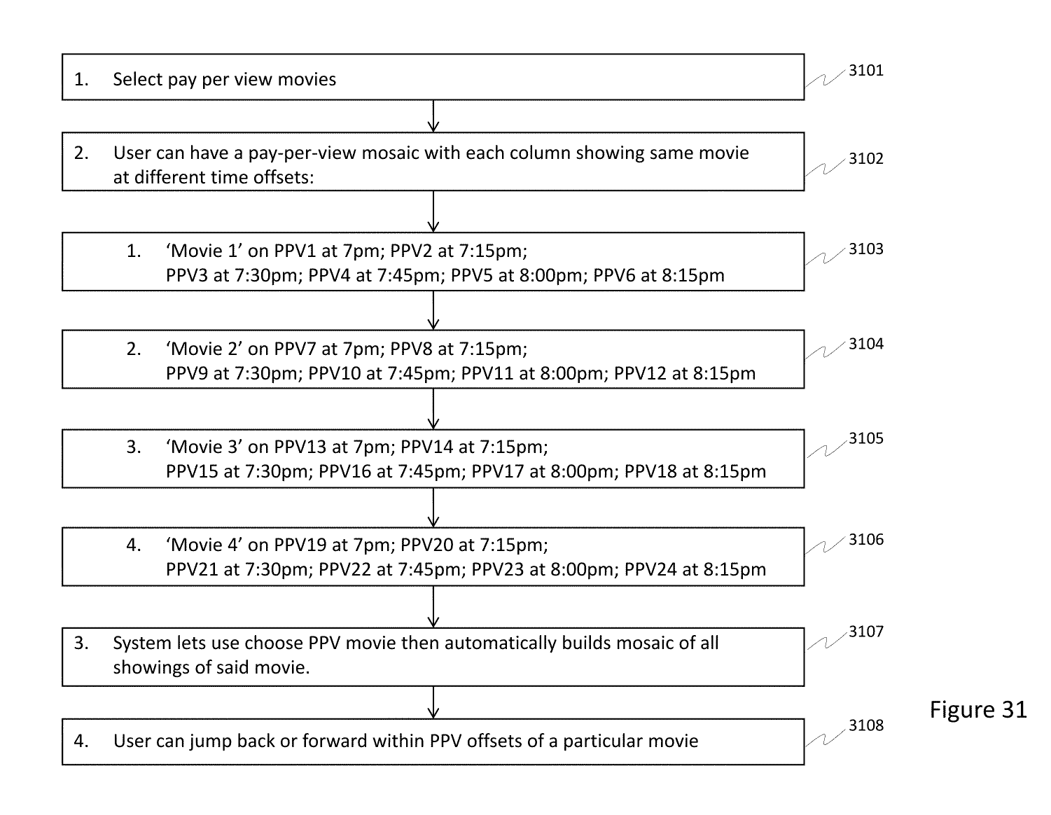

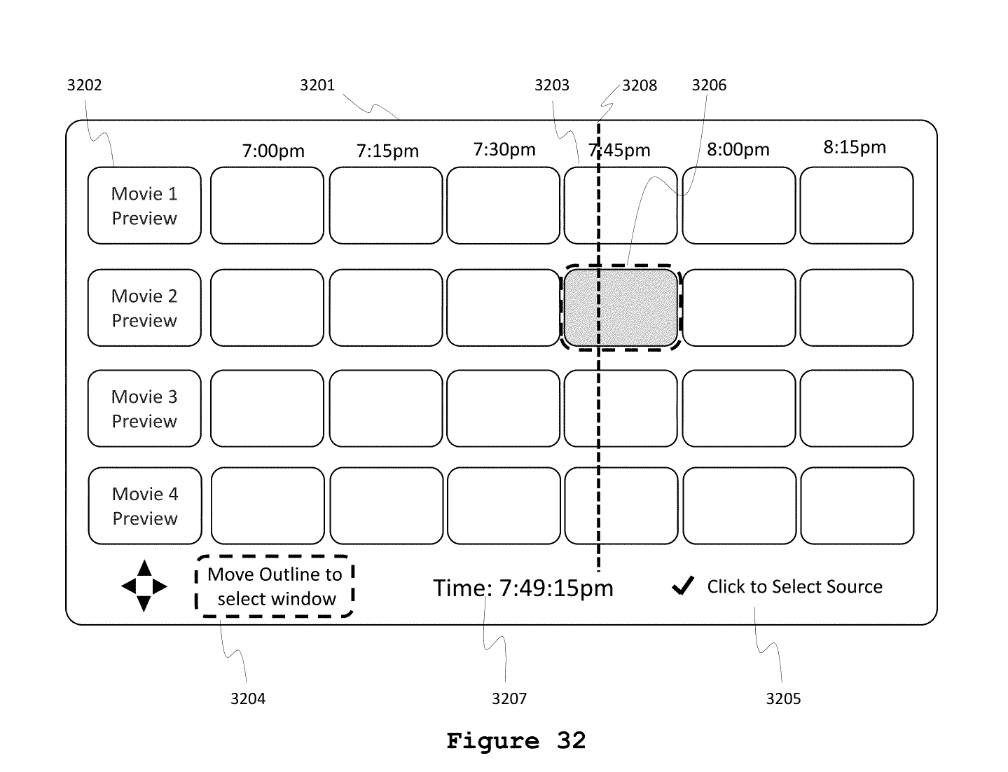

The server system can search and arrange the tiles of full-motion video displayed on the on-screen mosaic based on previous viewing patterns for a particular time (e.g., season, time of year, day of week, and/or time of day) corresponding to the current time. By way of example only, if a particular subscriber watches a lot of basketball games during the National Collegiate Athletic Association (NCAA) annual basketball championship in March, then all those games may be highlighted, clustered and/or automatically promoted to the top rows of the mosaic. See FIG. 29 as one example.

It can maintain viewing histories or stated entertainment preferences in separate accounts for different household members and enable different programming to be delivered to different viewing devices including for example only, other television sets, computers, tablets or smartphones.

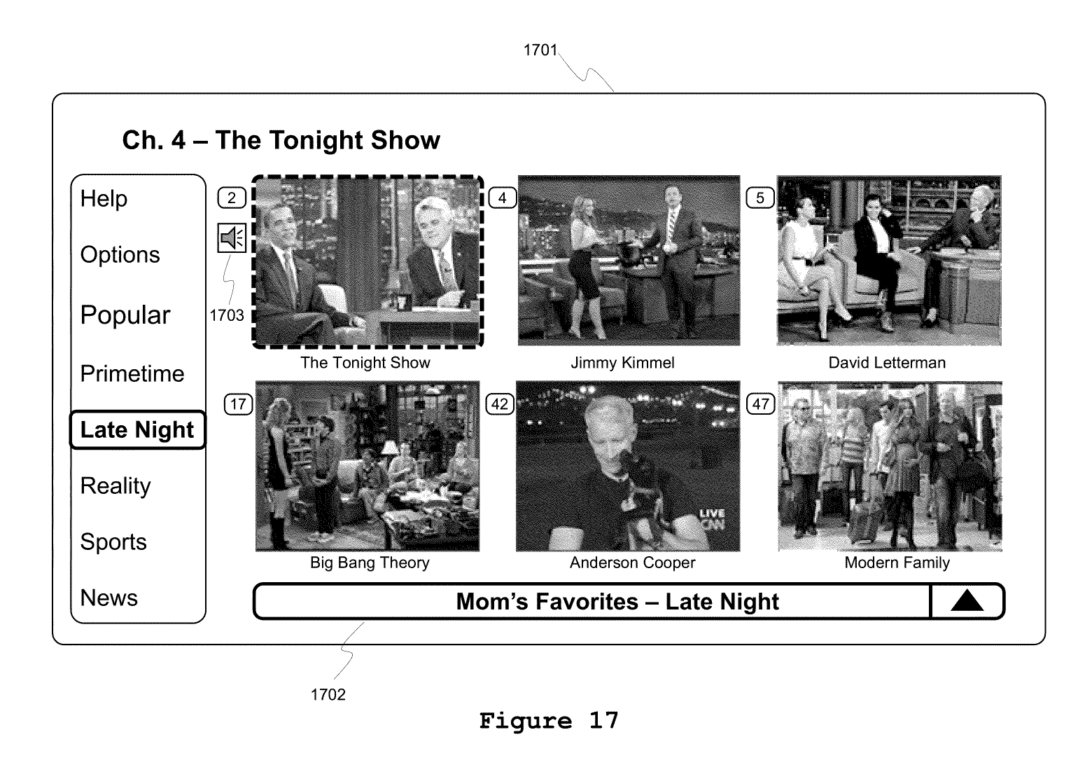

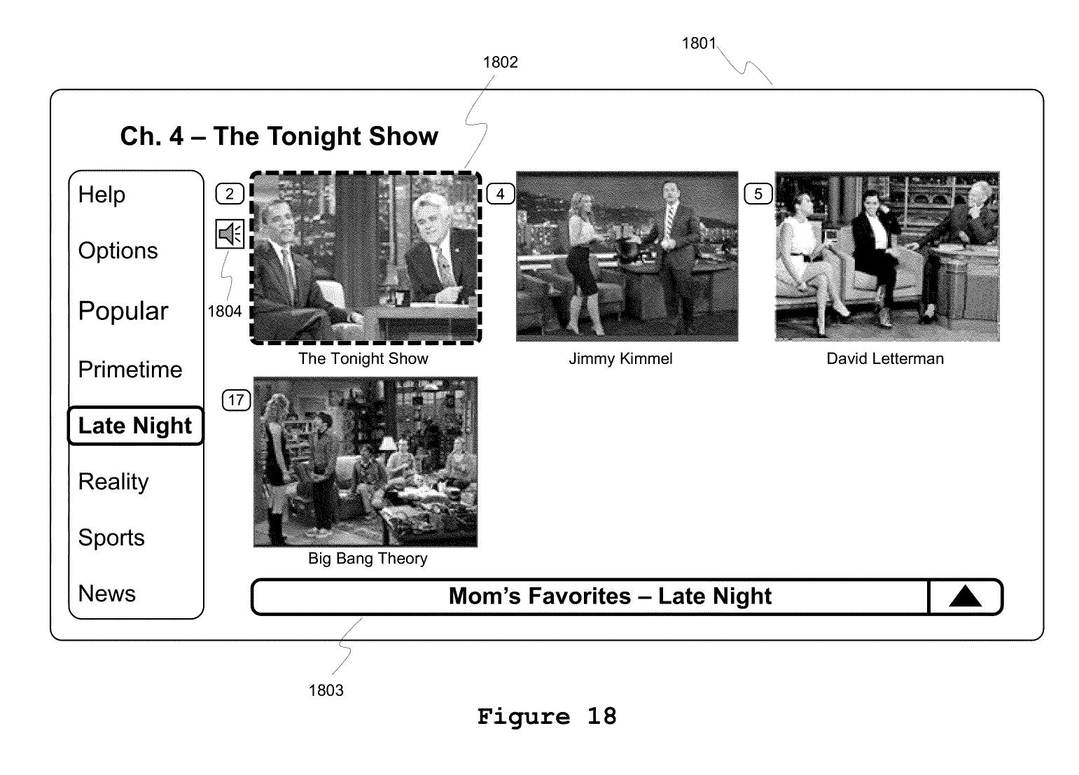

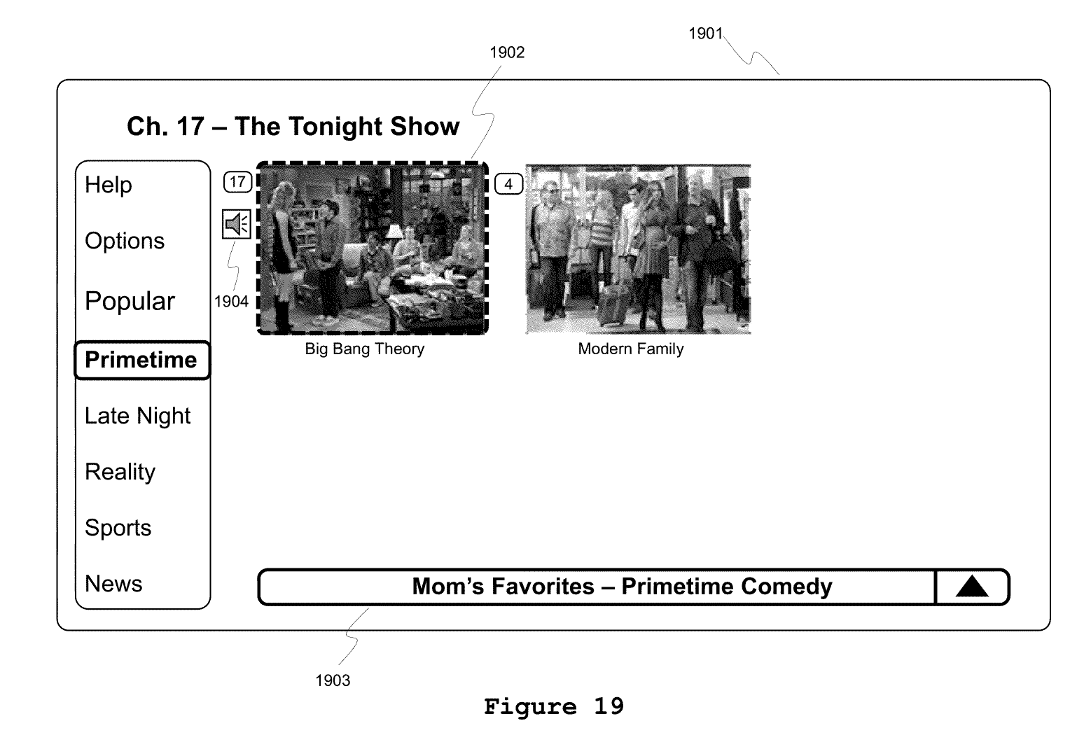

By way of example only, a first member of the viewing household may want to only have certain sports programming such as basketball (but no golf or tennis) highlighted or promoted to the top rows of the video mosaic, while a second member of the viewing household might prefer certain talk shows or certain types of movies given prominence. See FIG. 17 for example.

Similarly, the subscriber could specify a “family viewing” preference that highlights programming that might be consumed by a plurality of their household members sitting together. Such individualized content selection video mosaic interfaces may be displayed together on one screen or separately on different TV viewing devices.

An alternative embodiment of a household viewing guide could involve displaying a single row or column of video tiles for each household member, with each tile showing the programming currently available on one of the respective household member's favorite channels. The number of “favorite channel” tiles reserved for each household member is limited only by the resolution of the TV viewing device.

The server system is able to identify and be responsive to any household member's personal devices, such as smart phones or tablets, that it can detect as being present in a TV viewing room. The server system, on command by an app launch, automatically reorganizes the on-screen video mosaic to show some of each household member's currently available favorite TV programs in as many windows as proportionately available.

The server system will stream a user's video mosaic guide(s) to a second-screen such as a smartphone or tablet in addition to the television screen.

Individual family members (or household members) can each have their own custom video mosaic. Further, any user can have any mix of genres. As one example, the top two rows in the mosaic could be tiles displaying sports channels, the third row could be news programs and the fourth or bottom row in this example could be arranged by network channels, etc. In some embodiments, each family member has a row or column of the mosaic to populate with their respective favorite shows. The server system can also watch for certain keywords, such by way of example, “breaking news” and dynamically add a full-motion-video tile to the on-screen mosaic if a key word is detected.

This functionality is implemented as shown in FIG. 1 by software applications operating on a computer subsystem called a “video processing unit” 101 that among other functions resizes each video stream in the transcoder scaler component 101a according to the logic implemented by the software in the server system and then combines the resized video streams in a “compositor-stitcher” 101b. Should the potential selection be currently playing, the full-motion thumbnails or video tiles that make up the mosaic are synchronized with the actual broadcast.

These video representations are rendered and delivered to client TV viewing device for display without reliance on the characteristics of the customer premises equipment such as the number of tuners available in the TV set or set-top box.

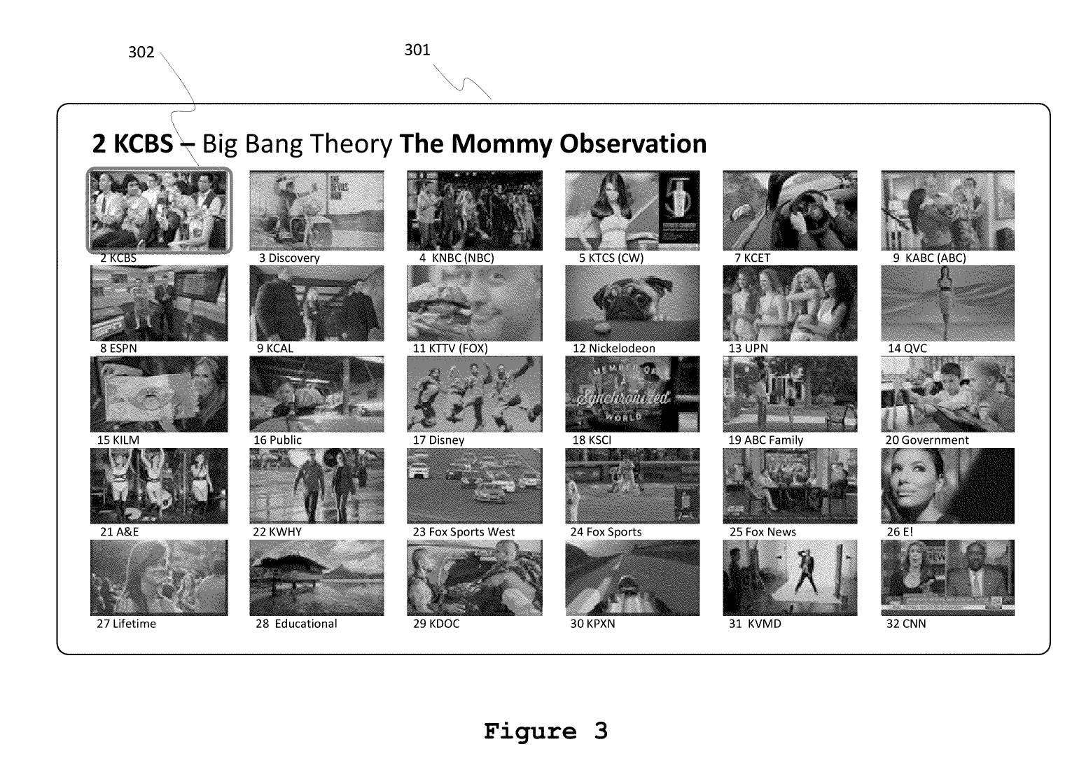

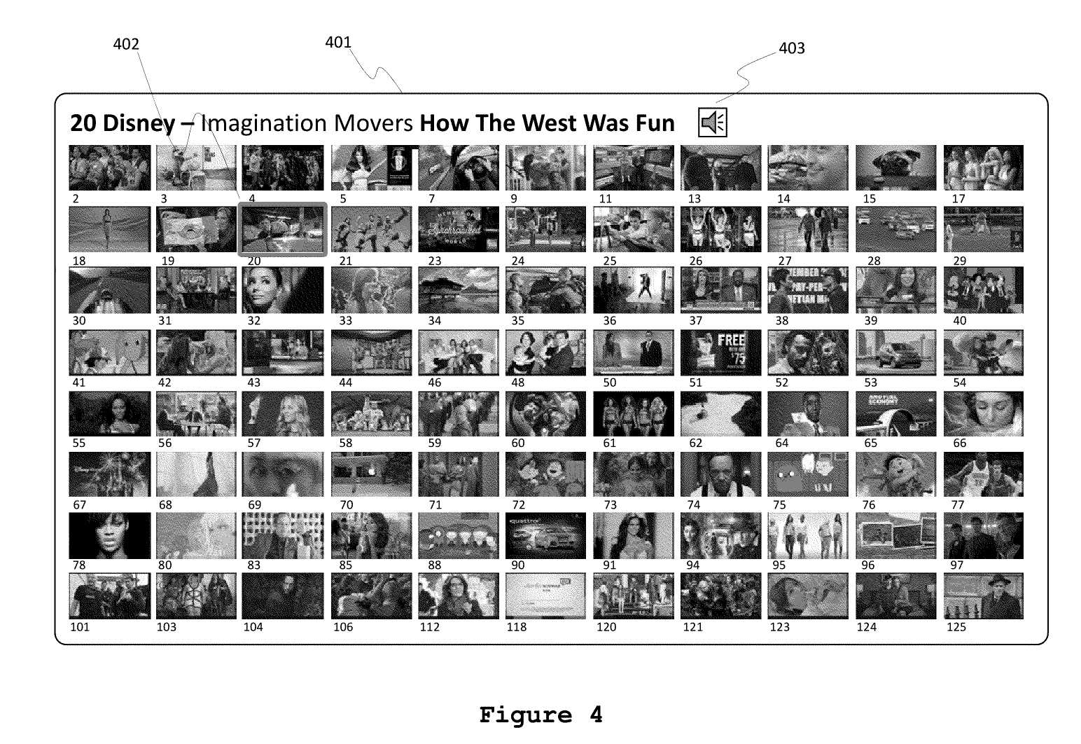

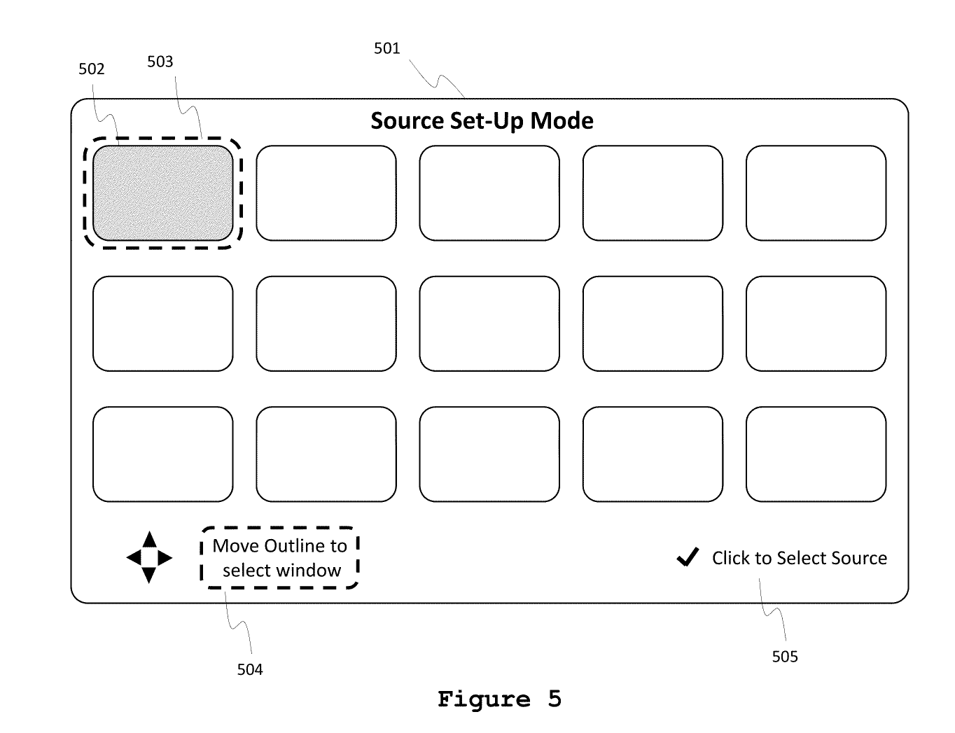

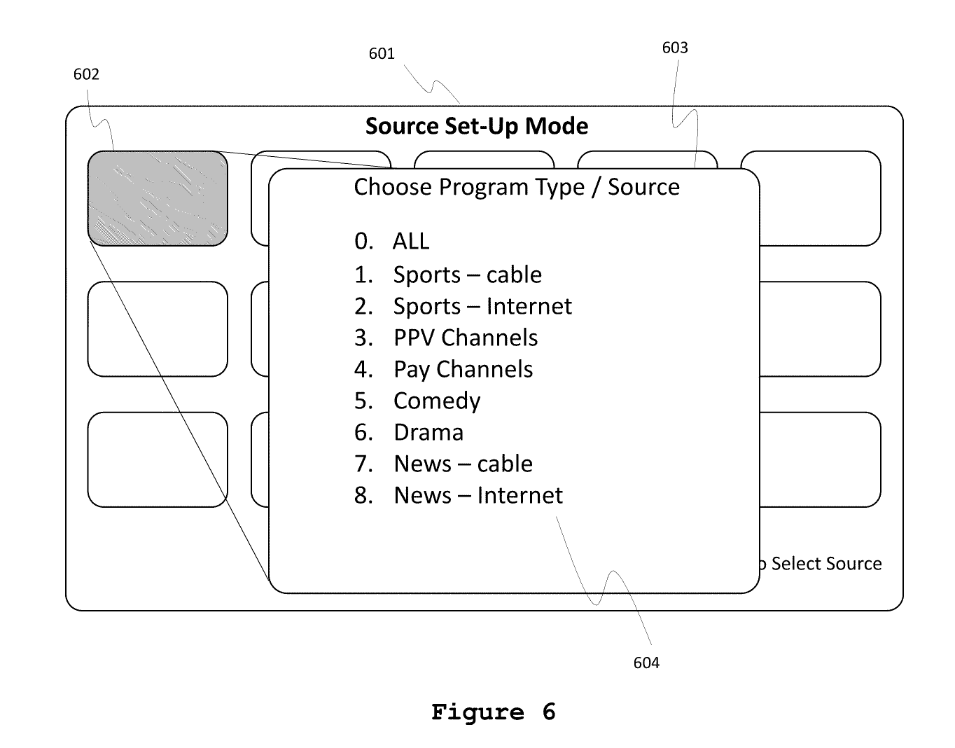

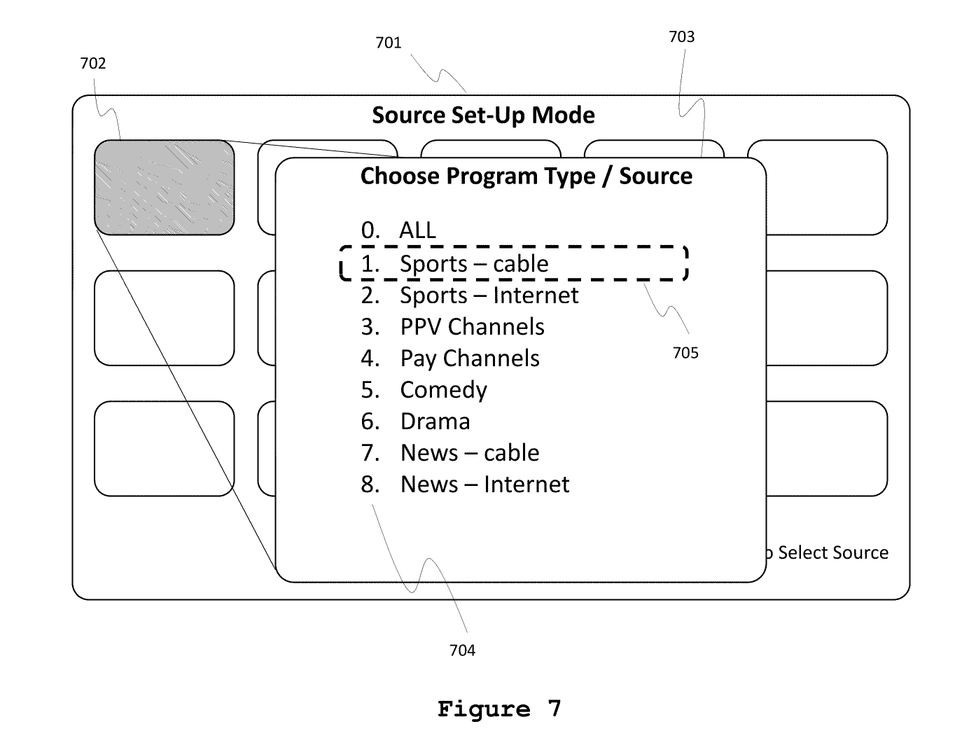

Individual video tiles may be selected, the audio for the video being displayed may be heard, and detailed additional text and still graphic information about the selection may be displayed as can be seen in the screen shots of FIG. 7 and FIG. 3.

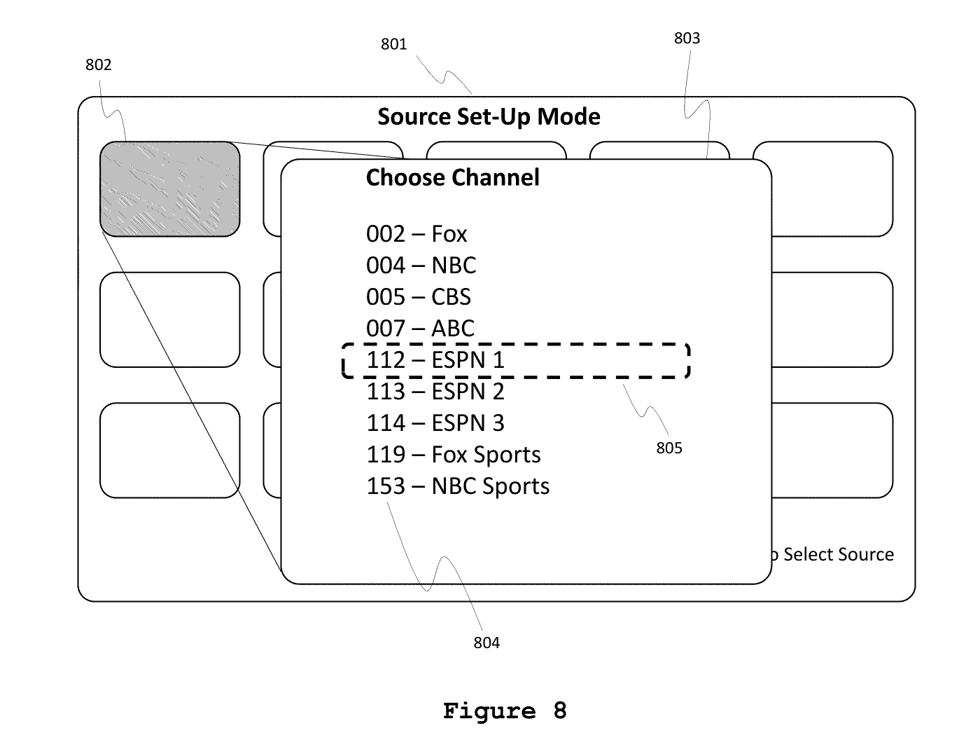

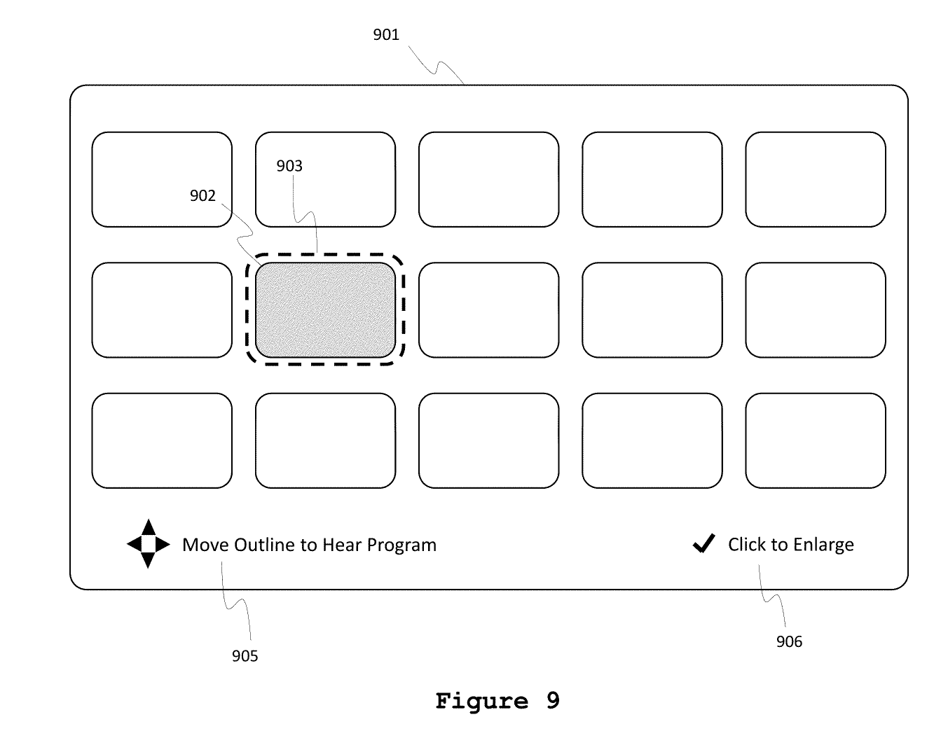

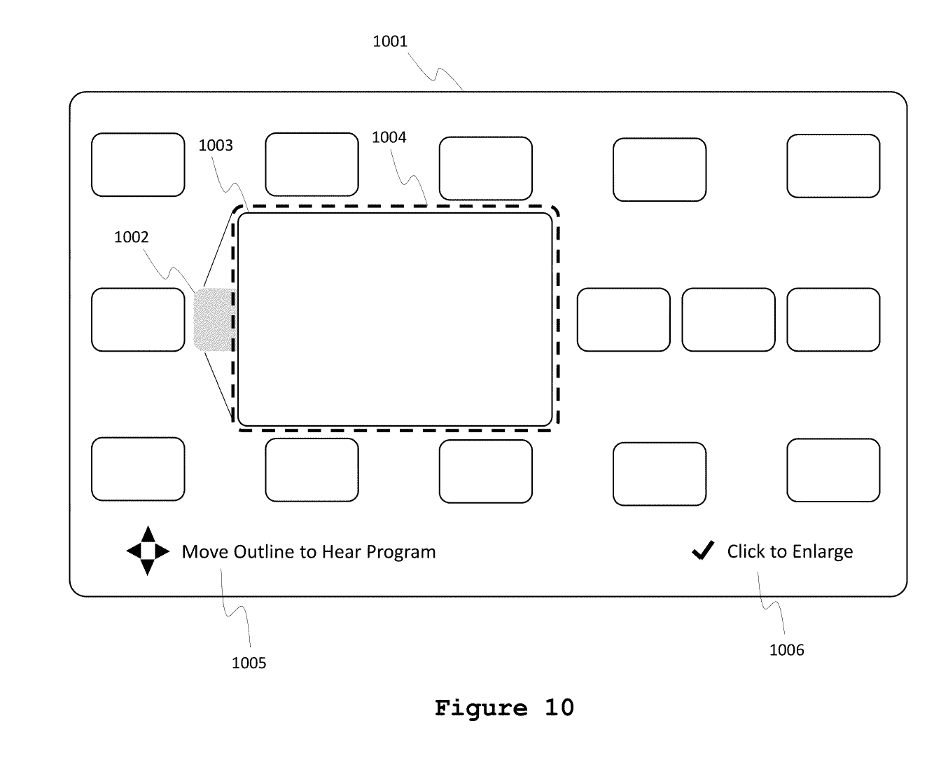

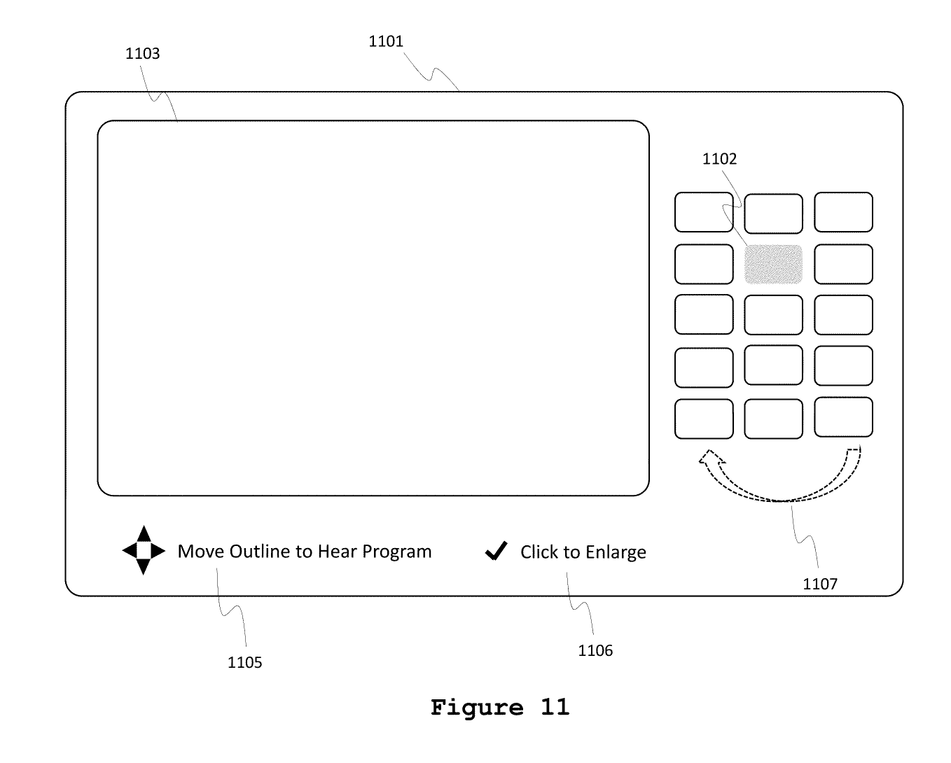

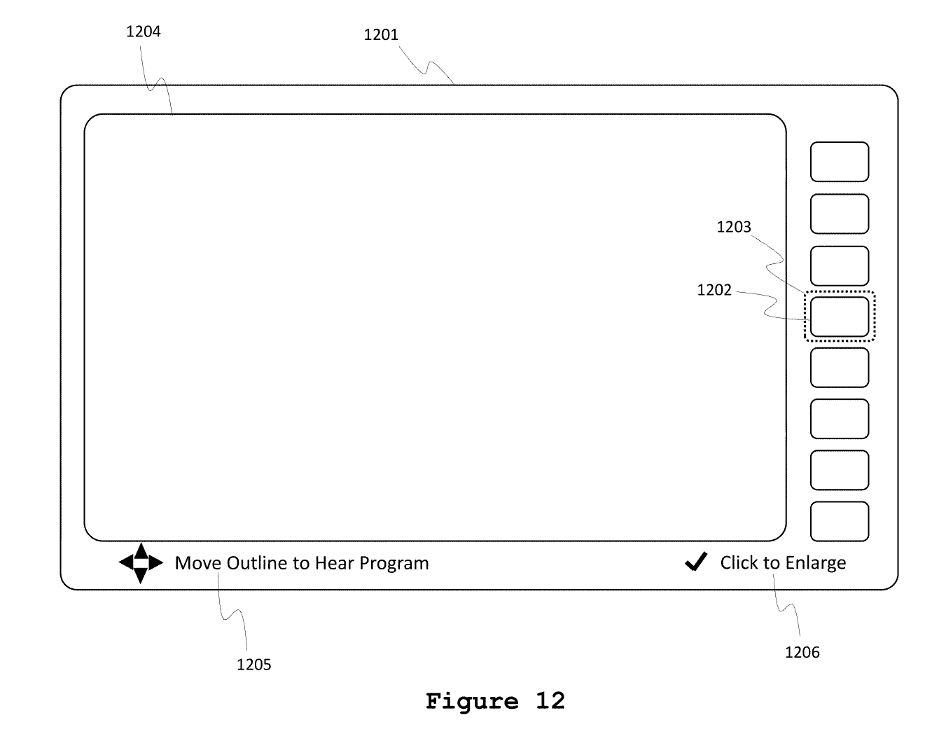

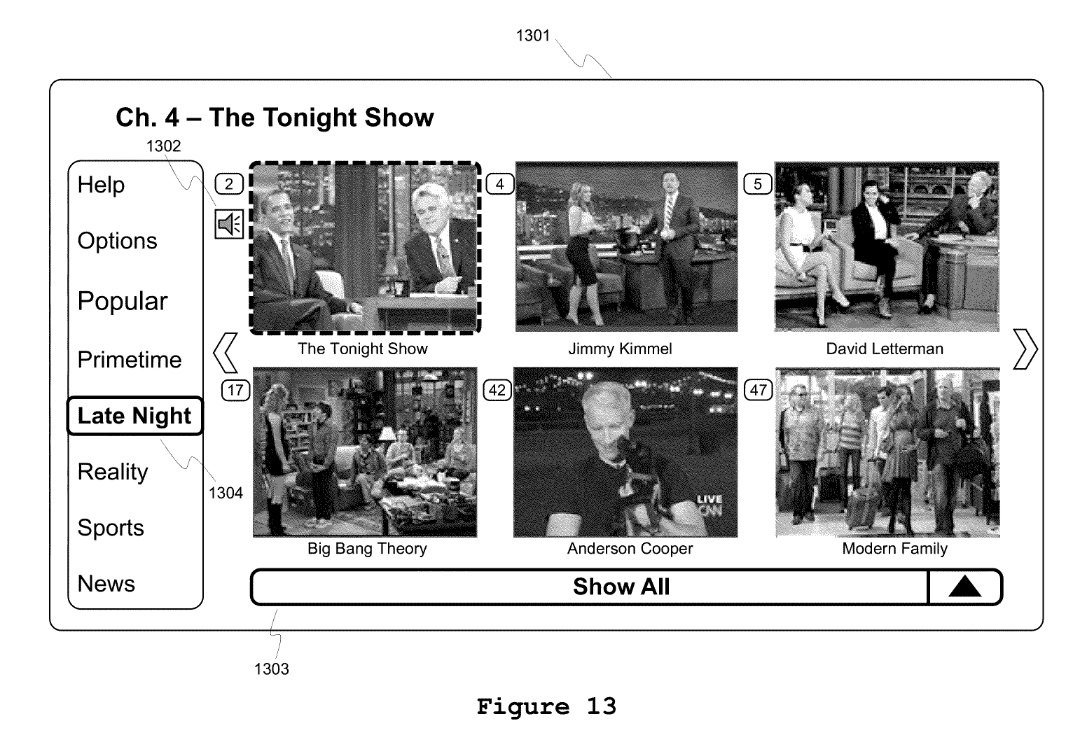

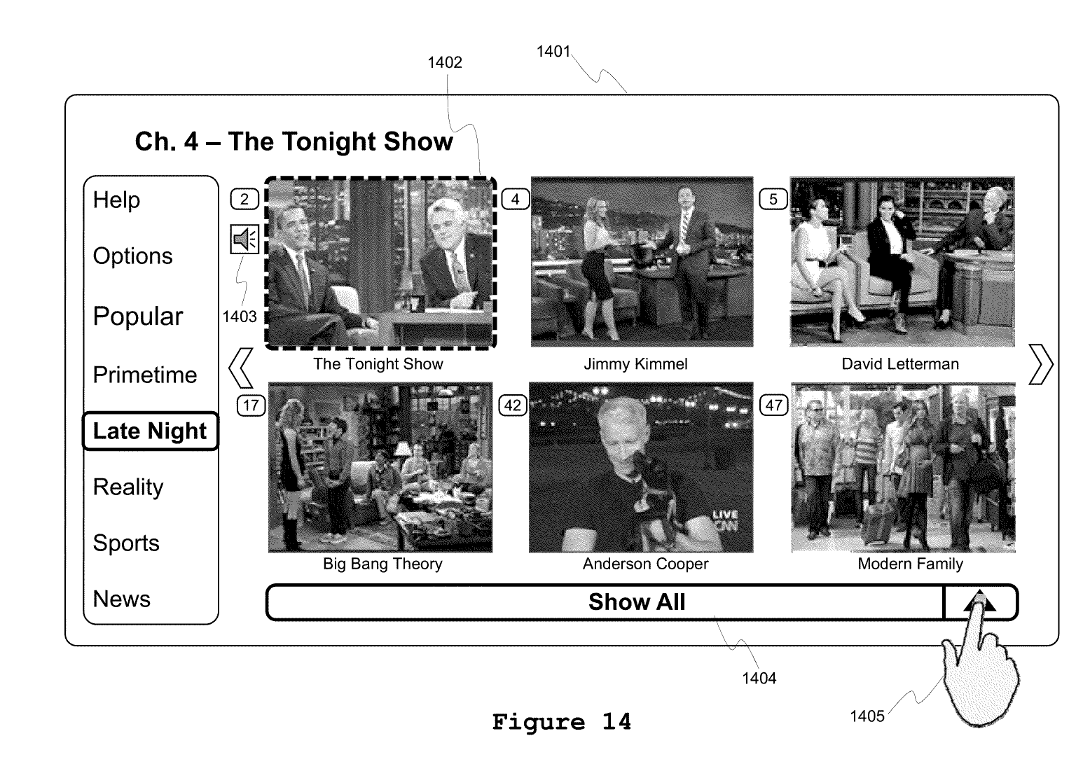

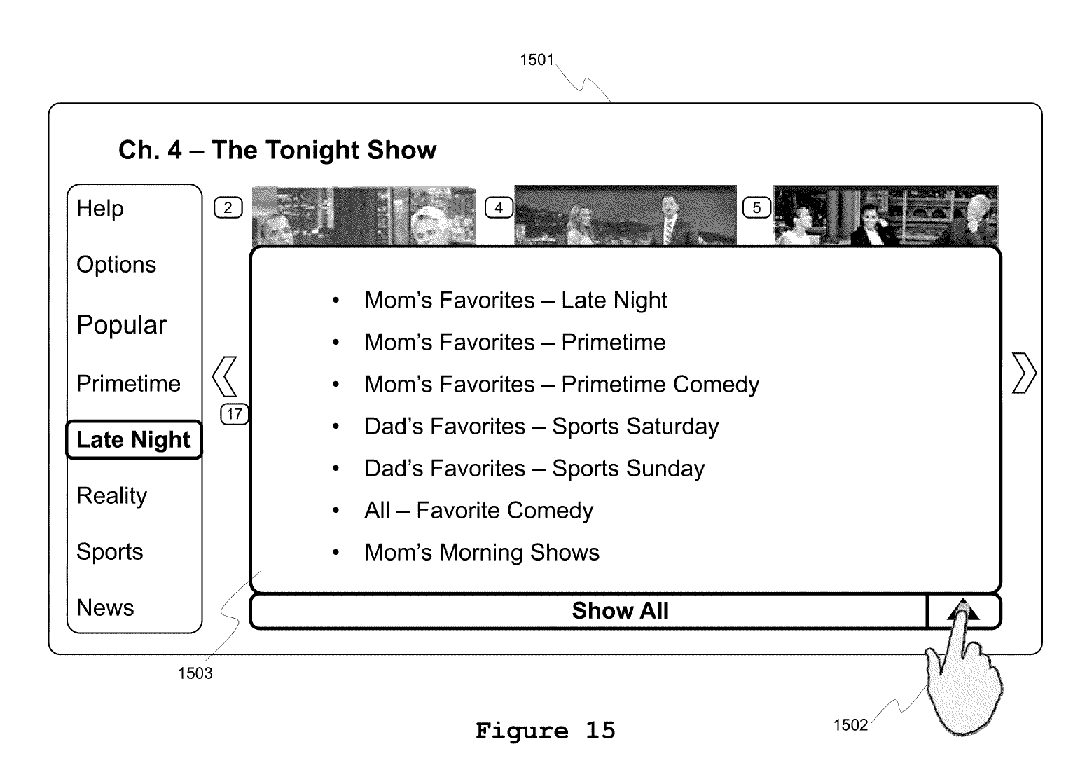

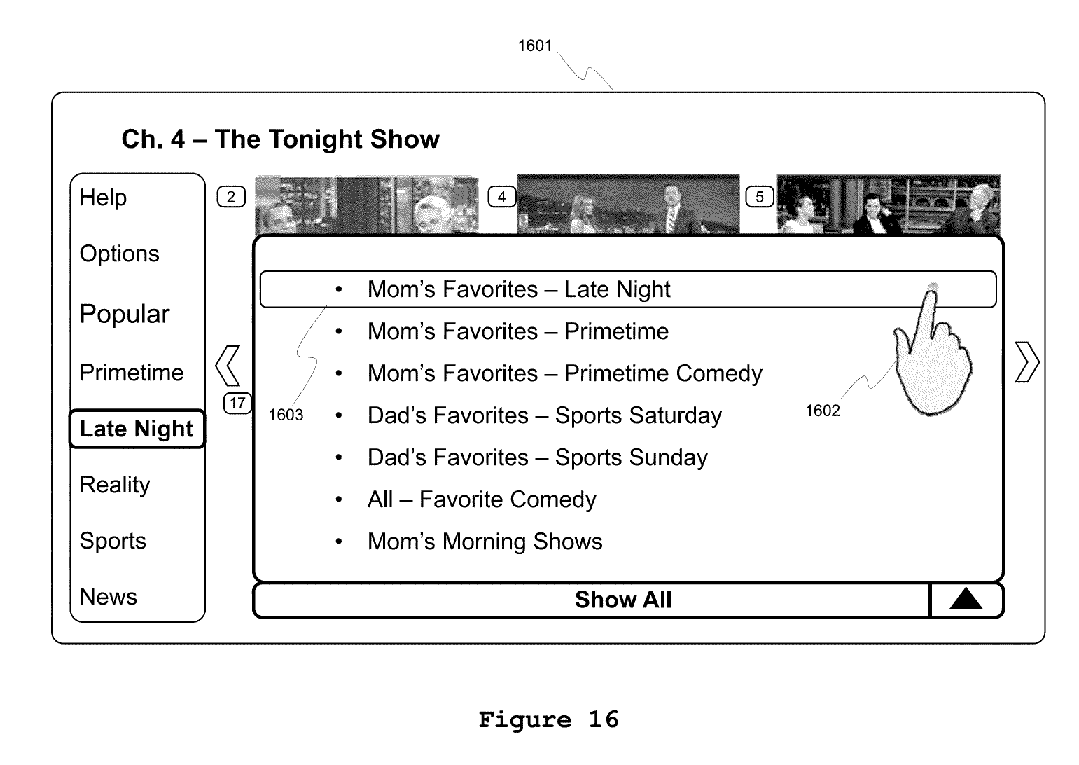

In some embodiments, users are able to search for or sort among available content using search queries. Such search queries may be predefined by the provider of the user interface, such that the user selects from a list of constraints or search queries such as the “Cable Sports on ESPN 1” query shown being selected in FIGS. 7 and 8. Users may generate their own search using natural language input in the form of speech or direct text input, Boolean operators, or the like, enabling customized video mosaics with any selection of content (e.g., broadcast content, content available over the Internet, and/or content locally stored on a DVR or other storage device).

As previously noted, in some embodiments, queries may include search constraints relating to popularity metrics derived from one or more Internet based social networks. For example, a predefined search query may include a search constraint for content that has received a certain number, or rate, of up-votes in a social network such as, by way of example, “Likes” on Facebook. As another example, a predefined search query may include a search constraint for content that has received a certain number of mentions by users of some selected social network. Mentions include, by way of example, Twitter “retweets” and/or “hashtags,” as well as Facebook “Posts,” and/or any other textual content within a social network that represents, relates to, or refers to particular content. FIG. 22 shows screen shots of this feature in operation.

Thus, search constraints relating to popularity metrics from social networks can be used to return results regarding specific content items, for example certain television shows or movies, that are popular among users of the selected social network. Also, information from various social networks may be accessible, such that the predefined queries can contain search constraints from different social networks, thus expanding the scope of information that can be used to generate useful search results (and/or sorting/filtering conditions) for the user.

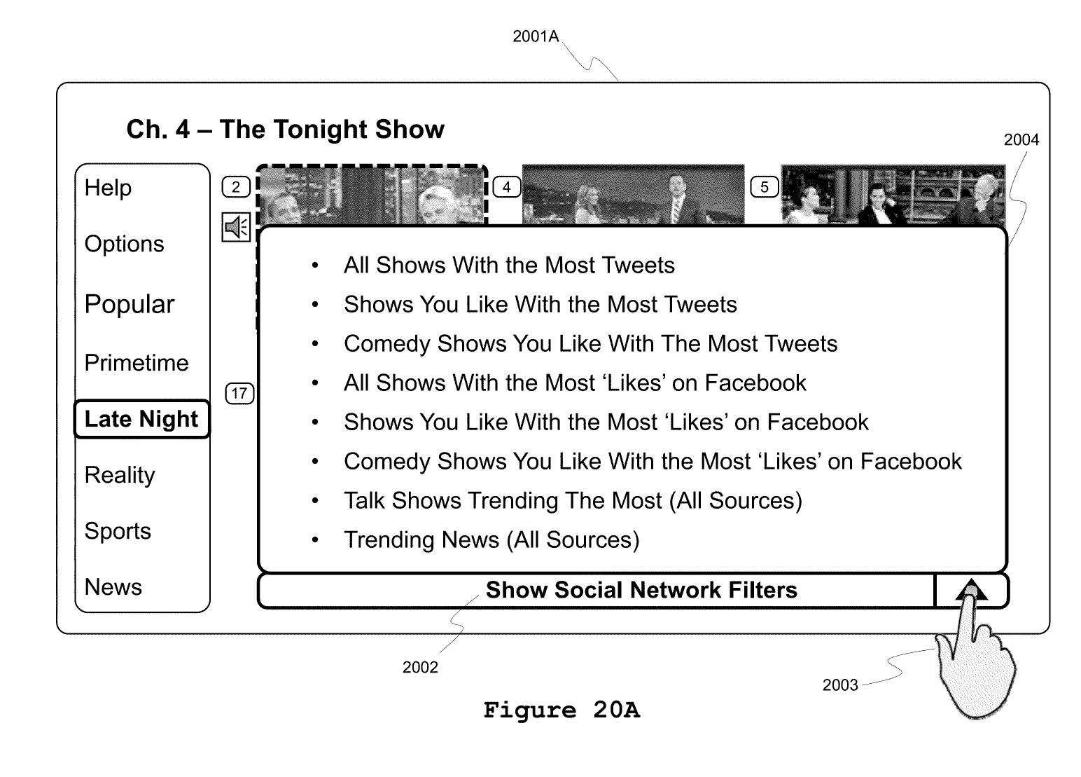

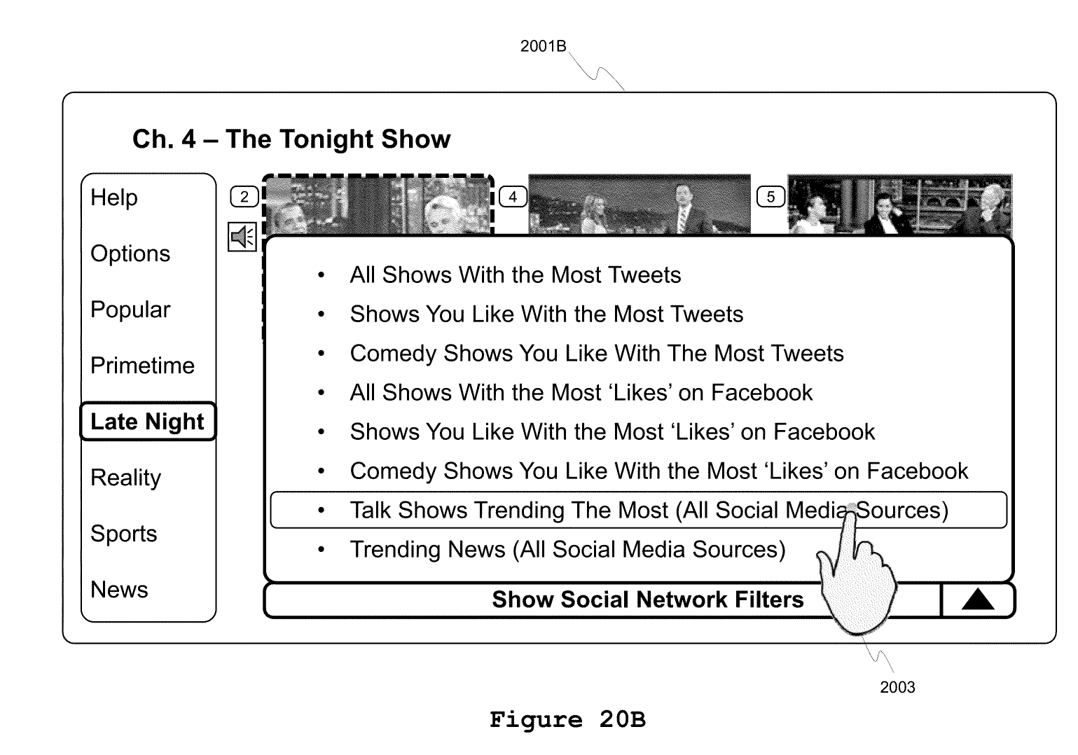

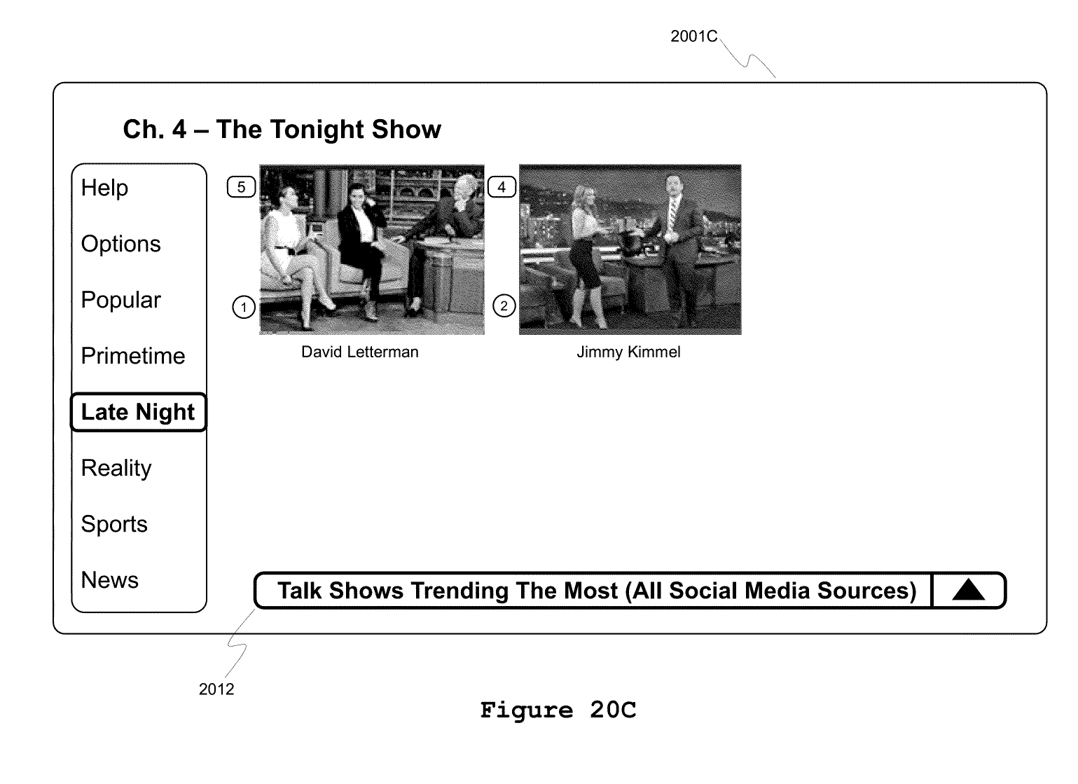

Additionally, search queries can combine popularity metrics from multiple different social networks to provide more comprehensive results of popular content. Specifically, instead of returning content items that are popular or trending in one social network, a search query may allow a user to search for content that is trending across multiple social networks. Thus, all of the most popular shows, even from different social networks, can be returned in the results from a single search query. FIGS. 20A-20C show screen shots illustrating this.

In some embodiments, popularity metrics are determined by the social networks themselves. For example, Twitter may determine whether a particular content item such as a television show or movie is “trending” (or a list of content items that are trending). Likewise, Facebook will determine whether a particular content item is popular, or a list of content items that are currently popular, and will inform the application server platform 100 (i.e., the server system). In response to a suitable request from a user, the application server platform 100 returns search results based on the information provided from the social networks.

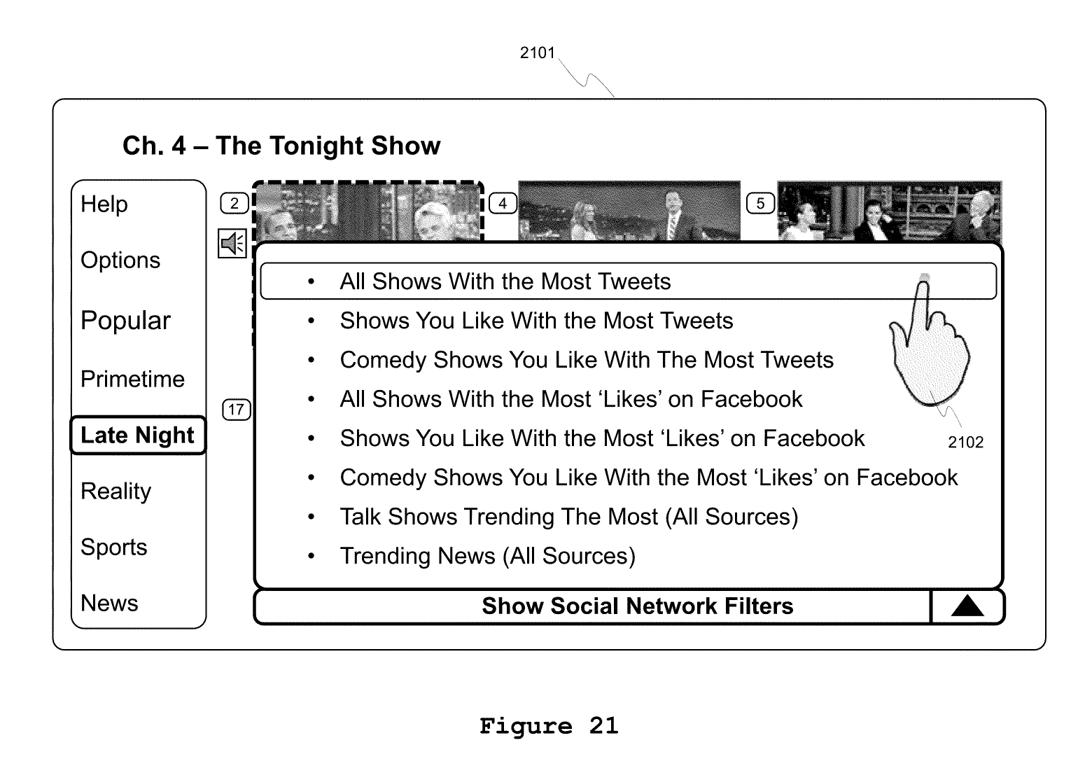

In some implementations, search queries include not only constraints relating to popularity of content in a social network, but also constraints relating to one or more other conditions. For example, a search query may include a constraint relating to genre, content type, and the like. As a specific example, a search query may be for “Comedies that are popular on Facebook” or “Talk shows that are the most popular across all social networks.” These search queries will return results that satisfy both of these constraints, or all of the constraints, if the query includes more than two constraints. See FIG. 21 for a screen shot showing an example of a similar multiple constraint search.

In summary, the service provider can determine the number of channels of video available to be displayed on the video grid including all available channels. Furthermore, in some embodiments the service provider provides video grids of non-real-time video, such as trailers of available movies from a video-on-demand server of the service provider or otherwise assessable, to client devices for viewing. Likewise, Internet content such as videos can be displayed in searchable, filterable arrays using all the metrics available to television programming including Nielsen ratings or ratings from other sources, or “trending” statistics from Twitter or other social media as well as search terms and filtering that are specific to content provided over the Internet. Hence, a client device that has only one television tuner, or no tuner and only the ability to decode a video stream, can show a mosaic of video tiles.

### Additional Configurations

In some embodiments, a method of generating an interactive graphical user interface for a television viewing device is provided. The method comprises formatting and rendering the interface on a computer system (e.g., the application server platform 100, FIG. 1) remote to the viewing device; and transmitting the completed interface to the television viewing device over one or more networks including QAM channel, managed IP, or public Internet.

In some embodiments, the interface may be configured, managed, accessed or controlled through any one or combination of certain electronic devices including a remote control device provided for the television viewing device or its associated devices, PC, laptop computer, tablet, smartphone or other compatible personal electronic device.

In some embodiments, the interface includes a user configurable, on-screen program guide that includes a mosaic of a plurality of video components or tiles, all of which are capable of simultaneous full-motion-video display.

In some embodiments, selecting an individual tile enables the user to hear the matching audio track and get additional information.

In some embodiments, the interface may be reconfigured by the user to display the available programming according to a plurality of attributes.

In some embodiments, at least one of the attributes by which a programming display may be controlled is the real-time popularity of the subject programming. In some embodiments, the popularity of the subject programming may be computed by one or more attributes including the number of system subscribers or other viewers currently watching the programming and metrics derived from social media discussions regarding the programming.

In some embodiments, a method is provided to alert the user by transmitting an SMS, text, graphic or other message to the user's smart phone when a personalized discovery filter detects a valid condition of the filter.

In some embodiments, a personalized discovery filter detects a valid condition of the filter and initiates a streaming session via the Internet to an Internet-connected device as specified by a user for real-time viewing of a program or multiple programs that were detected by the filter.

In some embodiments, a personalized discovery filter detects a valid condition of the filter and initiates a recording to a DVR, personal computer, or any video recording device as specified by a user for later viewing by the user of the program or multiple programs that were detected by the filter. (Detection of the program or multiple programs by the filter results in the valid condition of the filter.

The embodiments described herein may be implemented with many different forms of software, firmware, and hardware. The actual software code or specialized server, video manipulation, or transmission hardware used to implement the embodiments described, is not limiting. Thus, the operation and behavior of the embodiments are described without reference to the specific software code or computational hardware used, as software and control hardware may be designed to implement the embodiments based on the descriptions provided herein.

Examples of forms in which the functionality described herein may be embodied include, but are not limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method for generating an interactive graphical user interface, comprising, at a server system remote from a client device:
receiving, from the client device, user input selecting a first filter;
filtering available video programming using one or more search conditions corresponding to the first filter, to identify a first plurality of videos that satisfy the one or more search conditions, wherein the one or more search conditions comprise a criterion relating to a popularity metric for a social network;
generating a user interface comprising a first mosaic of selectable video tiles corresponding to the first plurality of videos, wherein respective videos of the first plurality of videos are played in respective video tiles of the first mosaic;
encoding the user interface as a video stream; and
transmitting the video stream containing the user interface toward the client device for display.

2. The method of claim 1, wherein the criterion relating to the popularity metric for the social network comprises a requirement that a video is trending on the social network.

3. The method of claim 2, further comprising receiving a list of trending videos from the social network.

4. The method of claim 1, wherein the criterion relating to the popularity metric for the social network is a criterion relating to a number of comments on the social network about a video.

5. The method of claim 1, wherein the criterion relating to the popularity metric for the social network is a criterion relating to a rate of mentions of a video on the social network.

6. The method of claim 1, wherein the criterion relating to the popularity metric for the social network is a criterion relating to a number of up-votes on the social network for a video.

7. The method of claim 1, wherein the criterion relating to the popularity metric for the social network is a criterion relating to the popularity of a video among friends of a user of the client device, as indicated by activity of the friends on the social network.

8. The method of claim 7, further comprising receiving a list of the friends from the client device.

9. The method of claim 1, wherein the one or more search conditions comprise criteria relating to popularity metrics for a plurality of social networks.

10. The method of claim 9, wherein:
the criteria relating to popularity metrics for the plurality of social networks comprise a requirement that a video is trending on each social network of the plurality of social networks; and
the method further comprises receiving lists of trending videos from the plurality of social networks.

11. The method of claim 1, wherein the one or more search conditions further comprise specification of a genre.

12. The method of claim 1, wherein the first filter is customized for a respective member of a household associated with the client device.

13. The method of claim 1, wherein each video of the first plurality of videos is a full-motion video.

14. The method of claim 1, wherein the one or more search conditions corresponding to the first filter further comprise a criterion based on previous viewing patterns for a user of the client device for a particular time corresponding to a current time.

15. The method of claim 1, wherein the user interface further comprises a menu listing a plurality of filters, the method further comprising:
receiving, from the client device, user input selecting a second filter from the menu;
filtering available video programming using one or more search conditions corresponding to the second filter, to identify a plurality of videos that satisfy the one or more search conditions corresponding to the second filter;
updating the user interface to comprise a second mosaic of selectable video tiles corresponding to the second plurality of videos, wherein each video of the second plurality of videos is played in a respective video tile of the second mosaic;
encoding the updated user interface as a video stream; and
transmitting the video stream containing the updated user interface toward the client device for display.

16. The method of claim 15, wherein the one or more search conditions corresponding to the second filter combine the one or more search conditions corresponding to the first filter with one or more additional search conditions.

17. The method of claim 1, further comprising, after transmitting the video stream containing the user interface toward the client device for display:
receiving, from the client device, user input selecting a video tile in the first mosaic;
updating the user interface to:
display a video corresponding to the selected video tile in a region of the user interface that is larger than the selected video tile; and
display a second mosaic of selectable video tiles corresponding to the first plurality of videos, the second mosaic having fewer video tiles than the first mosaic and being displayed outside of the region;
encoding the updated user interface as a video stream; and
transmitting the video stream containing the updated user interface toward the client device for display.

18. The method of claim 1, further comprising:
receiving one or more triggering criteria from the client device, the one or more triggering criteria including a trigger relating to a popularity metric for a social network;
determining that an available video program satisfies the one or more triggering criteria; and
in response to determining that the available video program satisfies the one or more triggering criteria, issue an alert to the client device indicating that the available video program satisfies the one or more triggering criteria.

19. A server system, comprising:
one or more processors; and
memory storing one or more programs configured to be executed by the one or more processors, the one or more programs including instructions for:
receiving, from a client device, user input selecting a first filter;
filtering available video programming using one or more search conditions corresponding to the first filter, to identify a first plurality of videos that satisfy the one or more search conditions, wherein the one or more search conditions comprise a criterion relating to a popularity metric for a social network;
generating a user interface comprising a first mosaic of selectable video tiles corresponding to the first plurality of videos, wherein respective videos of the first plurality of videos are played in respective video tiles of the first mosaic;
encoding the user interface as a video stream; and
transmitting the video stream containing the user interface toward the client device for display.

20. A non-transitory computer-readable storage medium storing one or more programs configured for execution by a server system, the one or more programs comprising instructions for:
receiving, from a client device, user input selecting a first filter;
filtering available video programming using one or more search conditions corresponding to the first filter, to identify a first plurality of videos that satisfy the one or more search conditions, wherein the one or more search conditions comprise a criterion relating to a popularity metric for a social network;
generating a user interface comprising a first mosaic of selectable video tiles corresponding to the first plurality of videos, wherein respective videos of the first plurality of videos are played in respective video tiles of the first mosaic;
encoding the user interface as a video stream; and
transmitting the video stream containing the user interface toward the client device for display.
